(19) United States
(12) Patent Application Publication
(10) Pub. No.: US 2010/0303414 A1
(43) Pub. Date: Dec. 2, 2010

(54) CHIP-BASED SLOT WAVEGUIDE SPONTANEOUS EMISSION LIGHT SOURCES

(76) Inventors: Harry A. Atwater, JR., South Pasadena, CA (US); Ryan M. Briggs, Monrovia, CA (US); Mark L. Brongersma, Redwood City, CA (US); Young Chul Jun, Stanford, CA (US); Thomas L. Koch, Califon, NJ (US); Ravi Sekhar Tummidi, Bethlehem, PA (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/799,171

(22) Filed: Apr. 20, 2010

Related U.S. Application Data
(60) Provisional application No. 61/214,313, filed on Apr. 22, 2009.

(51) Int. Cl. G02B 6/30

(52) U.S. Cl. 385/49; 385/14

(57) ABSTRACT

An optical device includes an optically emitting material producing spontaneous emission and an optical waveguide coupled to the optically emitting material. The spontaneous emission from the optically emitting material is emitted into at least one optical mode of the optical waveguide. The optical waveguide coupled to the optically emitting material does not provide optical gain, and the presence of the optical waveguide causes the spontaneous emission rate to be substantially more rapid than in the absence of the optical waveguide. The optical waveguide causes the more rapid spontaneous emission rate over a broad range of frequencies.

### CROSS REFERENCE TO RELATED APPLICATION

This application claims the benefit of U.S. Provisional Application 61/214,313, filed Apr. 22, 2009, which is incorporated by reference in its entirety herein.

This invention was made under a contract with an agency of the United States Government, and the United States Government has certain rights in the invention.

### FIELD OF THE INVENTION

The present invention relates generally to optical waveguide devices and, more particularly, to optical waveguide devices that preferentially enhance the rate of spontaneous emission into the optical waveguide without requiring optical gain or an optical resonator.

### BACKGROUND OF THE INVENTION

There are many applications of photonics that involve the manipulation or direction of optical energy using optical waveguides. These include applications that route information that is encoded on the optical energy, such as might be used for transmitting, broadcasting, or receiving data in optical communications apparatus, or manipulating or directing optically-encoded data in computational systems or signal processing systems. Other applications that entail the manipulation or direction of optical energy in waveguides may include systems designed for optically sensing chemicals, biological species, temperature, pressure, or other environmental factors. Other applications include the advantageous direction of optical energy, such as may be required for solar concentrators designed to optimize the efficiency of electrical power generation by photovoltaic or thermal means.

In some applications that manipulate or direct optical energy in optical waveguides, external optical energy is incident upon the waveguide and substantial engineering is required to optimize the efficient coupling of the optical energy into the waveguide. In other applications, however, it may be desirable or even required that the optical energy be generated locally in the same device, chip, module, or sub-system that contains the waveguide. This generation of optical energy usually involves the emission of light from an excited material or an excited atomic species, or possibly through a nonlinear or parametric process involving additional other sources of optical energy. A critical design feature of such systems is the efficient coupling of the optical energy emitted by the excited material into a waveguide for subsequent utilization in the intended application. Another critical design feature is the efficiency of the light generation process itself. Yet another critical design feature is the spectral or coherence properties of the light that is generated, and the spectral range that can be handled by the design.

One approach to this problem involves creating a laser in the waveguide system, such that the laser light is efficiently or preferentially emitted into the waveguide. This is inherently possible by the nature of laser operation. In particular, the waveguide can be designed to include a resonator that is incorporated into the waveguide or otherwise efficiently coupled to the waveguide. The resonator can be furthermore designed to include a medium with optical gain, achieved through stimulated emission of optical energy, that can be increased by some means of excitation. When the optical gain for any particular resonance, or resonating mode, of the resonator is increased to a point where it compensates for the losses of the resonator, the laser achieves threshold and any additional energy applied to increase the excitation of the gain medium is efficiently converted into optical emission into the resonator mode. While this can lead to highly efficient emission into a waveguide, it requires the incorporation of a resonator, the inclusion of a medium providing optical gain, and optical gain that is sufficiently large to equal or exceed the losses of the resonator. Additionally, because the laser operation involves one or more resonator modes, the laser emission typically has a very narrow spectrum and a very high degree of coherence.

In cases where the conditions to achieve a laser are deemed undesirable, physically impractical, expensive, or otherwise unnecessary, another means to generate light locally in the waveguide system is through spontaneous emission rather than stimulated emission. For example, in some applications the spectral properties of spontaneous emission are advantageous relative to stimulated emission or laser sources, and spontaneous emission is the preferred light source. This includes applications where incoherent light, or a broadband spectrum, are desirable. Examples of devices using spontaneous emission include electrically excited spontaneously emitting material such as light emitting diodes (LEDs), or other optically-excited fluorescing material. The spontaneously emitting material can be incorporated either directly into a waveguide or in a geometry that tries to maximize the coupling of the spontaneously emitted light into the waveguide. Applications for such spontaneously emitting waveguide sources include optical communications, optical gyroscopes, and a large variety of optical sensors for biomedical, chemical, and environmental applications, including but not limited to interferometric sensors, optical coherence tomography, and absorption spectrometry. The engineering and design of systems addressing these applications are well known to those skilled in the art using conventionally known spontaneous emission light sources. However, these conventional sources have significant drawbacks and, if improved inventive devices were available to address these drawbacks, the resulting inventive systems could have significant improvements in their performance.

A fundamental drawback of most spontaneous emitting light sources is due to the nature of the spontaneous emission process. Such light sources typically emit spontaneous emission into all the available modes of the system. In most cases, these available modes comprise different directions of emission, and thus the spontaneous emission source typically emits in all directions. It is therefore very difficult to collect the spontaneously emitted light and efficiently couple it into a waveguide. Systems with large-core multi-mode waveguides can capture a significant fraction of the spontaneously emitted light from properly designed spontaneous emission sources such as LEDs, but even in these cases a typical fraction of optical energy coupled into the multi-mode waveguide may be only ˜10% or even less. If single-mode waveguides or fiber are used, this percentage may drop in a typical case to below 2%.

If the spontaneous emission source is incorporated directly into the waveguide these percentages can be increased somewhat, and devices such as edge-emitting LEDs emit significant power into a waveguide mode. Even well-designed spontaneous emission sources suffer from the fact that, in most circumstances, the emission into all the available modes or direction is nearly equally likely. Therefore, in single-mode waveguides, it is often anticipated in the design of such sources of light that only the spontaneous emission that lies within the solid angle subtended by the waveguide mode will be captured by the waveguide mode. This is often expressed mathematically by saying that the fraction of spontaneous emission f emitting into the forward and backward modes of the waveguide mode is given by

$$f \sim \frac{1}{4 π} {( \frac{λ}{n} )}^{2} \frac{1}{{A}_{mode}}$$

where A_{mode} is a measure of the cross-sectional area of the optical mode of the waveguide.

In some cases, highly efficient edge-emitted LEDs have been designed to utilize stimulated emission, or optical gain, to provide an amplification of light that is emitted into the waveguide mode. These devices are sometimes termed superluminescent LEDs, or SLDs, or SLEDs, and can have fairly good efficiencies for coupling the optical energy generated by the device into a waveguide mode. However, similarly to the case of the laser, these devices require that there be optical gain, or stimulated emission, in the device and also that the gain resulting from stimulated emission exceed the propagation loss of the waveguide so that net gain is achieved. For highly efficient operation, a very significant excess gain is required.

Another difficulty often encountered in spontaneous emitting light sources relates to the efficiency. It is often the case that there are non-radiative decay paths for excited materials that compete with the radiative pathway. The energy deposited to excite the material is then divided such that some of the energy is emitted as the desired light, but other energy is wasted in the non-radiative pathways or decay channels. It is highly advantageous if the radiative channel or pathway can be made so rapid that very little of the energy is wasted in the non-radiative channel.

Another difficulty often encountered is spontaneous emitting light sources relates to their modulation characteristics. Because the excitation can only change the output on the timescale of the recombination time τ, the bandwidth of the modulation of spontaneous emitting light sources is typically limited to frequencies on the order of the inverse of the recombination time, typically with a relation

$${f}_{- 3 d B} \approx \frac{1}{2 π τ}$$

While non-radiative recombination can make the recombination time τ short, then the efficiency suffers as noted above. It is therefore highly desirable to have a very short radiative decay time to promote high modulation bandwidth while still maintaining high efficiency.

It is, therefore, desirable to design a spontaneously emitting device that does not require optical gain or an optical resonator, but still leads to high efficiency in the conversion of excitation energy into optical energy propagating in a waveguide mode and also offers a high modulation bandwidth.

### SUMMARY OF THE INVENTION

To achieve these and other objects, and in view of its purposes, the present invention provides a design and means for placing an excited material or atomic species, or other spontaneously emitting source, in a specially designed slot waveguide structure that results in high efficiency in the conversion of excitation energy into optical energy propagating in a waveguide mode and also offers a high modulation bandwidth. This is achieved by designing the slot waveguide and placing the excited material or atomic species, or other spontaneously emitting source, in such a manner as to substantially increase not just the fraction of emission into the desired waveguide mode relative to other modes or directions, but to also substantially increase the actual net total rate of spontaneous emission. The result is a highly efficient transfer of the excitation energy into optical energy propagating in the waveguide mode. Because the actual rate is increased, the modulation bandwidth is also increased. Also, because the actual rate is increased, the deleterious impact of any non-radiative recombination on efficiency can be dramatically reduced. These important features result in a highly useful and efficient waveguide source of optical energy that may be advantageously used for applications including, but not limited to, data communications, signal processing, sensors, and optical energy conversion. These applications are intended to be exemplary and not restrictive, and many additional applications are expected for such an efficient light emitter. The engineering and design of systems addressing these applications are well known to those skilled in the art using conventionally known spontaneous emission light sources. However, the features of the inventive devices enable inventive systems that provide significant improvements in their performance.

It is to be understood that both the foregoing general description and the following detailed description are exemplary, but are not restrictive, descriptions of the invention.

### BRIEF DESCRIPTION OF THE DRAWING

The invention is best understood from the following detailed description when read in connection with the accompanying drawing. It is emphasized that, according to common practice in the semiconductor industry, the various features of the drawing are not to scale. On the contrary, the dimensions of the various features are arbitrarily expanded or reduced for clarity. Included in the drawing are the following figures:

FIGS. 1-2 are depictions useful in analyzing the mathematical description of the spontaneous emission process;

FIGS. 3-4 are views of a slot waveguide in accordance with one embodiment of the invention;

FIG. 5 is a plot of the inverse of effective thickness of a waveguide for TE and TM modes;

FIG. 6 is a plot of the numerically calculated spontaneous emission rates and rate enhancement for different optical modes in accordance with one embodiment of the invention;

FIG. 7 is a plot of the total spontaneous lifetime reduction in accordance with one embodiment of the invention;

FIGS. 8 and 9 show numerical calculations of the spontaneous emission rates and enhancements into various modes of the a system in accordance with yet another embodiment of the invention;

FIG. 10 illustrates a spontaneous emission waveguide source that exhibits enhanced spontaneous emission into the TM slot waveguide mode in accordance with one embodiment of the invention;

FIG. 11 illustrates a fabrication sequence that can be used to realize the embodiment of the invention illustrated in FIG. 10;

FIG. 12 illustrates an experimental apparatus used to optically excite an embodiment of the invention;

FIG. 13 illustrates the emission spectrum measured from an embodiment of the present invention;

FIG. 14 illustrates the time-resolved spontaneous emission in response to a step function optical excitation from an embodiment of the invention;

FIG. 15 illustrates a detailed view of the spontaneous emission decay in time using higher time resolution from an embodiment of the invention;

FIG. 16 illustrates two different decay rates observed for the spontaneous emission produced by an embodiment of the invention;

FIG. 17(a) illustrates spontaneous emission of a control sample in response to a step function optical excitation;

FIG. 17(b) illustrates decay of luminescence on a log scale;

FIG. 18 illustrates enhanced spontaneous emission into the TM slot waveguide mode when an optical excitation source injected into the waveguide is used to excite an embodiment of the invention;

FIG. 19 illustrates enhanced spontaneous emission into the TM slot waveguide mode when an optical excitation source incident through the surface of the waveguide layers is used to excite an embodiment of the invention;

FIG. 20(a) illustrates enhanced spontaneous emission into the TM slot waveguide mode when an electrical excitation source is used to excite an embodiment of the invention;

FIG. 20(b) illustrates an exemplary geometry for providing electrical excitation to the material or species that is excited in the waveguide slot layer;

FIG. 21 illustrates enhanced spontaneous emission into the TM slot waveguide mode when an optical source is used to excite a nonlinear medium and cause spontaneous parametric fluorescence in an embodiment of the invention;

FIG. 22 illustrates enhanced spontaneous emission into the TM slot waveguide mode that is directed predominantly into one direction through the incorporation of a mirror in the waveguide in an embodiment of the invention;

FIG. 23 illustrates enhanced spontaneous emission into the TM slot waveguide mode in an embodiment of the invention that contains more than one slot layer; and

FIG. 24 illustrates enhanced spontaneous emission into the TM slot waveguide mode when an optical excitation source incident through the surface of the waveguide layers is used to excite an embodiment of the invention, and the enhanced spontaneous emission is converted to electrical power using conversion devices at the edge of the waveguide.

### DETAILED DESCRIPTION OF THE INVENTION

One area where waveguide optical sources have become an area of interest is in silicon photonics. Silicon photonics has shown great promise for achieving optoelectronic integrated circuits (OEIC's) designed to be fabricated in a silicon CMOS electronics foundry, and also the integration of optical functions with standard VLSI circuitry functions on a single silicon chip. Recent developments include foundry-fabricated Mach-Zehnder modulators with speeds as high as 40 Gb/s.

The ability to combine optical communications and sensor devices with control, amplification, and signal-processing electronics at very low cost is extremely compelling for markets including telecommunications, biomedical and environmental sensors, and military signal processing. Today's silicon photonics typically employs external InP-based or GaAs-based laser sources that are coupled onto the chip using surface gratings or edge coupling with mode transformers to match the high-index-contrast waveguides that optimize performance and density in the silicon photonics chip. This demands complex hybrid III-V and silicon packaging solutions, and thus the advent of silicon photonics can be viewed as merely a shift in the partitioning between III-V and silicon technologies within a module. The development of a more fundamentally Si-based light source, however, could allow for a complete compact, low-cost, low-power CMOS-compatible single-chip solution.

Approaches to this goal have focused on achieving optical gain and laser operation, and have included (1) signal generation using nonlinear optical gain techniques, (2) hybrid materials and intimate packaging solutions using proven III-V optical gain media, (3) “extrinsic” solutions using electrically-excitable Er ions, nanocrystals, defect structures, or other species introduced into Si, SiO₂ or other dielectrics to achieve optical gain, and (4) “intrinsic” solutions utilizing engineered SiGe structures to achieve optical gain, and (5) intersubband designs such as quantum-cascade active media to achieve optica gain and laser action.

While these approaches have shown some promise, as lasers they all require a medium or system providing optical gain, combined with an optical resonator, and do not offer a design or means for an efficient source of spontaneously emitted light. There has been some theoretical and experimental work demonstrating an enhancement of spontaneous emission into a particular optical mode based upon the so-called Purcell effect. This effect, first described by Purcell in 1946, has been described as an enhancement of the spontaneous emission rate into a resonator mode due to the significant increase in the density of states, or number of optical modes per unit energy, that occurs in resonators with large quality factor Q, and the commonly quoted Purcell enhancement factor F is

$$F = \frac{6}{{π}^{2}} {( \frac{λ}{2 n} )}^{3} \cdot \frac{Q}{V}$$

where V is the volume of the resonator. This enhancement of spontaneous emission would be highly desirable because it would mean that spontaneous emission is emitted preferentially into the resonator mode. This resonator mode could in turn be coupled to a waveguide, or be incorporated into the waveguide, such that energy leaking out of the resonator is efficiently injected into the waveguide for use in the intended application. Additionally, if there are competing de-excitation pathways for the spontaneously emitting material, species, or system, such as non-radiative recombination, the increase in rate for the spontaneous emission into the resonator mode also leads to a relative de-emphasis of the competing de-excitation pathways. As a result, in addition to the preferential emission into the resonator mode, the Purcell effect also has the potential to actually improve the net radiative emission efficiency.

The method described above, however, suffers from the deficiency of additionally requiring a resonator. Typically to achieve a large Purcell enhancement factor F also requires the realization of a high quality factor Q in a low volume V which can be quite difficult to accomplish. Thus, whereas such a source may not require optical gain, it does require an optical resonator.

There have been experiments that explore small enhancements in spontaneous emission rates that occur as a result of environmental factors that are not resonators. These include slight spontaneous emission rate modification for excited material or atomic species near the surface of a mirror, or near the surface of a dielectric. In such cases, there has been the prediction and observation of small increases in the spontaneous emission rate into freely propagating optical modes that impinge on the mirror or dielectric interface. These increases, while noted, have been typically small (˜2 or less) and the resultant spontaneously emitted light is not generated in a waveguide or inherently coupled with high efficiency into a waveguide mode. In such cases, a large fraction of spontaneous emission also continues to radiate into other freely propagating modes of the system, and is thus not readily available for use in the system. As a result of these factors, experiments that explore Purcell enhancement of spontaneous emission for practical use have focused on resonators and the enhancement captured in the Purcell factor F above.

Very recently we have conducted work in devices utilizing metal surfaces and plasmonic optical modes that have been predicted to provide a significant enhancement in spontaneous emission rates into the plasmonic modes. These devices, realized in geometries that are similar to some conventional CMOS capacitors and field-effect transistors, are interesting but require the use of metal surfaces and plasmonic optical modes. As such, any spontaneous emission into the plasmonic modes is not coupled with any inherent efficiency into a waveguide that can direct or manipulate the light for subsequent use in many applications. In particular, plasmonic modes suffer from very high propagation loss and thus can not be routed over any extended distance.

Most recently, we have come to the realization that so-called slot waveguide designs can also exhibit a remarkable and dramatic enhancement in spontaneous emission rates for excitations within the slot region. While we have been intensively investigating slot waveguides for use as an optical gain medium in lasers and optical amplifiers, there has not previously been a recognition that these structures can be configured to provide a spontaneously emitting light source with very high efficiency. Such a source is inherently different as it does not require the use of optical gain, and furthermore does not require the use of an optical resonator as is conventionally envisioned for the Purcell effect.

To further understand this enhancement in spontaneous emission rates we have performed extensive calculations that quantify the advantageous properties of spontaneous emission that can be advantageously harnessed in devices designed according to the principles of the present invention. These complete calculations are included in Jun et al “Broadband Enhancement of Light Emission in Silicon Slot Waveguides, Optics Express, Vol 17, No 9 (27 Apr. 2009). However, to provide a more pedagogical approach we also review here some relevant calculations of spontaneous emission in conventional media as well as in the inventive incorporation of slot spontaneous emission enhancement in devices according to the present invention.

As a reference point, we first quickly review the calculation of spontaneous emission for a simple exemplary two-level atomic system. FIG. 1 illustrates the radiative decay from a higher energy level 2 to a lower energy level 1 through the spontaneous emission of a photon. In a homogeneous medium of index n, group index n_{g} and relative dielectric constant ∈ᵣ=n². Fermi's Golden Rule provides us with the transition rate

$${W}_{if} = \frac{2 π}{ℏ} {\vert {H}_{if}^{′} \vert}^{2} δ ( {E}_{f} - {E}_{i} )$$

$$with$$

$${H}^{′} = - μ \cdot E and μ = e 〈 2 \vert x \vert 1 〉$$

For the homogeneous, dispersive dielectric medium, the electric field operator takes on the form,

$$E ( x , t ) = {\sum }_{l = 1 , 2} {\sum }_{k} \sqrt{\frac{{ℏω}_{k}}{2 {nn}_{g} {ɛ}_{0} V}} \cdot ( i a ( k , l ) {e}^{+ ik \cdot x - i ω t} {\hat{σ}}_{l} ( k ) - i {a}^{†} ( k , l ) {e}^{- ik \cdot x + i ω t} {\hat{σ}}_{l}^{*} ( k ) )$$

where \hat{σ}ₗ(k) are the polarization states. Here n and n_{g}=n+ω(∂n/∂ω) are the phase and group indices of the dispersive medium, and for the non-dispersive case this takes on the more often seen form with nn_{g}→n²=∈ᵣ. Assume that the “atomic” states in question have a non-vanishing matrix element in the \hat{z} direction only, using the coordinate system of the atomic system for example, so that

μ=e [symbol] 2|x|1 [symbol] =e [symbol] 2|z|1 [symbol] \hat{z}≡μ₂₁\hat{z}=μ₁₂*\hat{z}

such as would be the case between a hydrogen 2P_{z} and 1S state. We now calculate the rate for the transition from the state |E₂, N(k,l)=0 [symbol] to the state |E₁,N(q,m)=1 [symbol] for a particular value of wavevector \hat{q} and polarization \hat{σ}ₗ(q). By Fermi's Golden Rule we have

$$\begin{matrix}Rate = \frac{2 π}{ℏ} {\vert 〈 {E}_{1} , N ( q , m ) = 1 \vert \begin{matrix}{\sum }_{l = 1 , 2} {\sum }_{k} \sqrt{\frac{{ℏω}_{k}}{2 {nn}_{g} {ɛ}_{0} V}} \cdot \\ ( {a}^{†} ( k ) {e}^{- i k \cdot xt} {\hat{σ}}_{l}^{*} ( k ) ) \cdot z\end{matrix} \vert {E}_{2} , N ( k , l ) = 0 〉 \vert}^{2} \\ δ ( {E}_{f} - {E}_{i} ) \\ = \frac{2 π}{ℏ} \cdot \frac{{ℏω}_{q}}{2 {nn}_{g} {ɛ}_{0} V} \cdot {\vert {\hat{σ}}_{m}^{*} ( q ) \cdot \hat{z} \vert}^{2} {\vert {μ}_{21} \vert}^{2} δ ( {E}_{2} - {E}_{1} - {ℏω}_{q} ) \\ = \frac{2 π}{{ℏ}^{2}} \cdot \frac{{ℏω}_{q}}{2 {nn}_{g} {ɛ}_{0} V} \cdot {\vert {\hat{σ}}_{m}^{*} ( q ) \cdot \hat{z} \vert}^{2} {\vert {μ}_{21} \vert}^{2} δ ( {ω}_{q} - \frac{{E}_{2} - {E}_{1}}{ℏ} )\end{matrix}$$

where we have noted that

a(k)|E₂,N(k,l)=0 [symbol] =0 and [symbol] E₁,N(q,l)=1|a^{†}(k,l)|E₂,N(k,l)=0 [symbol] =δ_{k,q}δ_{l,m}

To now calculate the total spontaneous emission rate into all possible values of wavevector \hat{q} and polarization \hat{σ}ₘ(q), we need to sum over all \hat{q} and m values:

$$\begin{matrix}Total Rate = \frac{1}{{τ}_{sp}} \\ = \frac{2 π}{{ℏ}^{2}} \cdot {\sum }_{m - 1 , 2} {\sum }_{q} \frac{{ℏω}_{q}}{2 {nn}_{g} {ɛ}_{0} V} \cdot \\ {\vert {\hat{σ}}_{m}^{*} ( q ) \cdot \hat{z} \vert}^{2} {\vert {μ}_{21} \vert}^{2} δ ( {ω}_{q} - \frac{{E}_{2} - {E}_{1}}{ℏ} )\end{matrix}$$

Recalling that Fermi's Golden Rule was valid for a transition into a continuum of states, we can convert to a continuum approximation in this step. The number of states in a volume V with just one of the possible polarizations \hat{∈}ₘ(q) in an interval ΔqₓΔq_{y}Δq_{z} about wavevector \hat{q} is just

$$Δ {N}_{states} = ( Δ {q}_{x} Δ {q}_{y} Δ {q}_{z} ) \cdot \frac{V}{{( 2 π )}^{3}}$$

and if we convert this to spherical coordinates, we have

$${dN}_{states} = \frac{V}{{( 2 π )}^{3}} d φsin ( θ ) d θ \cdot {q}^{2} d q = \frac{V}{{( 2 π )}^{3}} d φ sin ( θ ) d θ \cdot \frac{{n}^{2} {n}_{g} {ω}_{q}^{2} d {ω}_{q}}{{c}^{3}}$$

where in the last step we have used the simple relation

$$dq = \frac{{n}_{g} d {ω}_{q}}{c}$$

including material dispersion effects. In the continuum approximation the summation is converted to an integral yielding

$$\frac{1}{{τ}_{sp}} = \frac{2 π}{{ℏ}^{2}} \cdot \frac{{Vn}^{2} {n}_{g}}{{( 2 π )}^{3}} {\sum }_{m = 1 , 2} {\int }_{0}^{2 π} d φ {\int }_{0}^{π} sin ( θ ) d θ {\int }_{0}^{∞} \frac{{ω}_{q}^{2} d {ω}_{q}}{{c}^{3}} ( \frac{{ℏω}_{q}}{2 {nn}_{g} {ɛ}_{0} V} \cdot {\vert {\hat{σ}}_{m}^{*} ( q ) \cdot \hat{z} \vert}^{2} {\vert {μ}_{21} \vert}^{2} ) δ ( {ω}_{q} - \frac{{E}_{2} - {E}_{1}}{ℏ} )$$

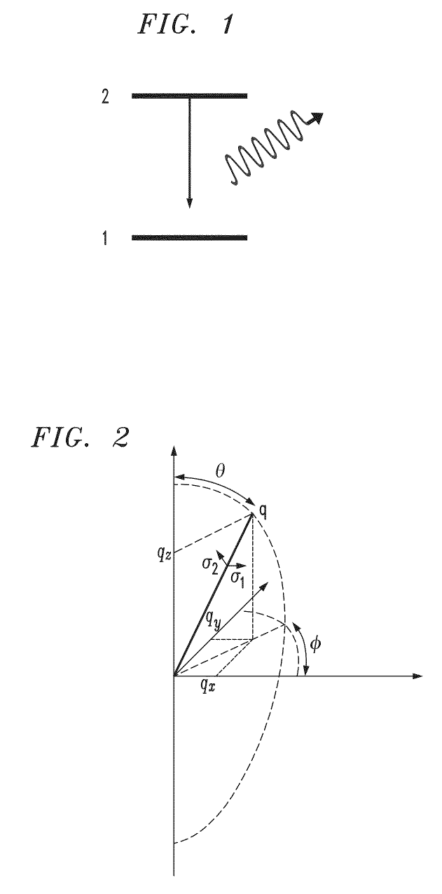

FIG. 2 is a diagram illustrating emission photon emission in a direction indicated by the wavevector \hat{q} with two different polarization states direction \hat{σ}₁(q) and \hat{σ}₂(q). If we think in the spherical coordinates as drawn in FIG. 2, we see that for any direction of wavevector \hat{q} there will be one polarization direction \hat{σ}₁(q) that is perpendicular to the \hat{z} direction for which |\hat{σ}₁*(q)·\hat{z}|=0, and one direction \hat{σ}₂(q) that lies in the vertical rotated plane for which |\hat{σ}₂*(q)·\hat{z}|=sin θ in our coordinate convention. Substituting ∈ᵣ=n² we then have

$$\frac{1}{{τ}_{sp}} = \frac{2 π}{{ℏ}^{2}} \cdot \frac{nV}{{( 2 π )}^{3}} \frac{{ℏω}_{0}}{2 {ɛ}_{0} V} \frac{{ω}_{0}^{2}}{{c}^{3}} {\vert {μ}_{21} \vert}^{2} {\int }_{0}^{2 π} d φ {\int }_{0}^{π} {sin}^{3} ( θ ) d θ$$

where

$${ω}_{0} ≡ \frac{{E}_{2} - {E}_{1}}{ℏ} .$$

Completing the angular integrals using

$${\int }_{0}^{2 π} d φ {\int }_{0}^{π} {sin}^{3} ( θ ) d θ = 2 π \cdot \frac{4}{3}$$

yields our final, standard result for the spontaneous lifetime in a dielectric medium of

$$\frac{1}{{τ}_{sp}} = \frac{{\vert {μ}_{21} \vert}^{2} n {ω}_{0}^{3}}{3 {πɛ}_{0} ℏ {c}^{3}}$$

which is of course independent of volume in this continuum mode limit. Note also that any effects of group index are absent because it appears in both the quantized field operator and in the density of states, and ultimately canceled out.

Spontaneous Emission Rate into Waveguide Modes

If we move from a homogeneous medium to a more general case with a spatially varying ∈ᵣ(x) as is typical for a dielectric waveguide system, the quantized electric field operator in a non-uniform dielectric medium is given by

$$E ( x , t ) = {\sum }_{n} \sqrt{\frac{{ℏω}_{n}}{2}} \cdot ( {ia}_{n} {e}^{- iω t} {A}_{n} ( x ) - {ia}_{n}^{†} {e}^{+ iω t} {A}_{n}^{*} ( x ) )$$

where the vector basis set Aₙ(x) we are expanding in (and invoking annihilation and creation operators for) satisfies the eigenvalue wave equation for the vector potential A(x)

$$- ∇ \times ( ∇ \times {A}_{n} ) = {∇}^{2} {A}_{n} - ∇ ( ∇ \cdot {A}_{n} ) = {ɛ}_{r} ( x ) \frac{{ω}_{n}^{2}}{{c}^{2}} {A}_{n}$$

along with the modified radiation gauge criterion (obvious from the equation above since ∇·(∇×F)=0) for any vector F)

∇·∈ᵣ(x)Aₙ=0

and these vectors are complete under the orthogonalization and normalization condition

$$〈 {A}_{m} \vert {A}_{n} 〉 ≡ {\int }_{V} {ɛ}_{0} {ɛ}_{r} ( x ) {A}_{m}^{*} \cdot {A}_{n} {d}^{3} x = {δ}_{n , m}$$

Note that the “vector potential” as used here has incorrect dimensions of

$$\sqrt{\frac{1}{{ɛ}_{0} V}}$$

However, the electric field operator used above incorporating this basis set is dimensionally correct and properly normalized.

If we temporarily ignore material dispersive effects for the sake of mathematical simplicity only, we will nevertheless be implicitly including any dispersive effects that result from a resonator or waveguide structure. For comparison purposes, the case of a homogeneous dielectric medium has ∈ᵣ(x)=∈ᵣ as a constant, so a modal expansion using the plane wave solutions becomes

$${A}_{n , l} ( x ) = \frac{1}{\sqrt{{ɛ}_{0} {ɛ}_{r} V}} {\hat{σ}}_{l} ( k ) {e}^{+ i {k}_{n} \cdot x}$$

and we have the conventional quantized field result that we just used to treat the spontaneous emission in a homogeneous medium. In passing, we note that in the literature sometimes a different vector basis set is employed where

Fₙ(x)≡\sqrt{∈₀∈ᵣ(x)}Aₙ(x)

in which case the normalization and orthogonalization relation takes on the simpler form

$${\int }_{V} {F}_{m}^{*} ( x ) \cdot {F}_{n} ( x ) {d}^{3} x = {δ}_{n , m}$$

and by substitution, the quantized field in this basis set has the form

$$E ( x , t ) = {\sum }_{n} \sqrt{\frac{{ℏω}_{n}}{2 {ɛ}_{0} {ɛ}_{r} ( x )}} \cdot ( i {a}_{n} {e}^{- iω t} {F}_{n} ( x ) - i {a}_{n}^{†} {e}^{+ iω t} {F}_{n}^{*} ( x ) )$$

The basis set Fₙ(x) does not lend itself to a rigorous formal canonical quantization procedure, and is also in general not a solution to Maxwell's equations in a medium with a spatially varying ∈ᵣ(x), while in contrast the quantity

$$\frac{{F}_{n} ( x )}{\sqrt{{ɛ}_{0} {ɛ}_{r} ( x )}}$$

is a solution of Maxwell's equations. Nevertheless, the fields Fₙ(x) are easily shown to be a complete set with the more conventional orthogonalization condition, and the field expression above resulting from this mathematical substitution is thus perfectly rigorous and appears often in the literature.

Returning to the basis set Aₙ(x) and the field operator

$$E ( x , t ) = {\sum }_{n} \sqrt{\frac{{ℏω}_{n}}{2}} \cdot ( i {a}_{n} {e}^{- iω t} {A}_{n} ( x ) - i {a}_{n}^{†} {e}^{+ iω t} {A}_{n}^{*} ( x ) )$$

we can then calculate the spontaneous emission of an excited atomic system through the matrix element for transition from excited state “b” to lower state “a” with the emission of a photon into the particular eigenmode represented by Aₙ(x).

[symbol]

(Nₙ+1,a|E(x)·ex|Nₙ,b

[symbol]

where Nₙ is the original number of photons in the mode Aₙ(x). This matrix element has the value

$$〈 {N}_{n} + 1 , a \vert E ( x ) \cdot e x \vert {N}_{n} , b 〉 = \sqrt{{N}_{n} + 1} \cdot {( \frac{{ℏω}_{n}}{2} )}^{\frac{1}{2}} {μ}_{b a} \hat{ρ} \cdot {A}_{n}^{*} ( x )$$

where μ_{ba}\hat{ρ}≡ [symbol] a|ex|b [symbol] [symbol] is the atomic dipole matrix element (with \hat{γ} being the unit vector in the direction of this dipole moment) and the summation for the electric field has collapsed due to our stipulation that we are dealing with the emission of a photon specifically into Aₙ(x) which is now evaluated at the position of the atom undergoing the transition.

Fermi's Golden Rule then stipulates that the transition rate is given by

$${W}_{f i} = \frac{2 π}{ℏ} {\vert 〈 {N}_{n} + 1 , a \vert W ( x , t ) \cdot e x \vert {N}_{n} , b 〉 \vert}^{2} δ ( {E}_{b} - {E}_{a} - ℏω )$$

$$or$$

$${W}_{f i} = ( {N}_{n} + 1 ) \cdot {πω}_{n} {\vert {μ}_{b a} \vert}^{2} {\vert \hat{ρ} \cdot {A}_{n}^{*} ( x ) \vert}^{2} δ ( {E}_{b} - {E}_{a} - ℏω )$$

Emission into a One-Dimensional Slab Guide Mode

As a particular application of this, consider the spontaneous emission rate into an arbitrary multi-layer slab waveguide mode in a sheet with linear dimensions in length and width of L. If the waveguide is terminated and we think of discrete frequencies for the longitudinal modes ωⱼ, we can represent this mode by an in-plane propagation constant

βₙ=βₓ_{ₙ}ŷ+β_{z}_{ₙ}\hat{z}

with the eigenfunction

$${A}_{n} ( x ) = A {e}^{i ( {β}_{{y}_{n}} y + {β}_{{z}_{n}} z )} \cdot {ϕ}_{n} ( x )$$

In this case, we can choose the coefficient A to cover the 1/\sqrt{∈₀} factor as well as the lateral dimension normalization 1/\sqrt{L²} and thus

$$A = \frac{1}{L \sqrt{{ɛ}_{0}}}$$

and if we impose periodic boundary conditions, we have βₙ≡βₙ(ωⱼ)=l·2π/Lŷ+m·2π/L\hat{z} with l,m=0, ±1, ±2, . . . . Here φₙ(x) is the vector lateral field solution for the waveguide mode designated by n, containing all of its polarization and spatial characteristics, and apparently then normalized to satisfy

$${\int }_{- ∞}^{∞} {ɛ}_{r} ( x ) {ϕ}_{n}^{*} ( x ) \cdot {ϕ}_{n} ( x ) d x = 1$$

Recalling that Fermi's Golden Rule only works meaningfully for transitions into a continuum of states, we recall that the 2-dimensional density of states for one polarization is given by

$$ρ ( {β}_{{y}_{n}} , {β}_{{z}_{n}} ) d {β}_{{y}_{n}} d {β}_{{z}_{n}} = \frac{{L}^{2}}{{( 2 π )}^{2}} d {β}_{{y}_{n}} d {β}_{{z}_{n}}$$

but if we switch to polar coordinates in the plane of the waveguide, we have

dβ_{y}_{ₙ}dβ_{z}_{ₙ}=dφβdβ

and we can integrate the azimuthal angle out yielding

$$ρ ( β ) d β = \frac{{L}^{2}}{{( 2 π )}^{2}} 2 πβ d β$$

However

$$β = \frac{{n}_{eff} ω}{c}$$

and including modal group dispersion,

$$d β = \frac{{n}_{eff \text{-} g} d ω}{c} = \frac{{n}_{eff \text{-} g} d E}{ℏ c}$$

$$yielding$$

$$ρ ( E ) d E = \frac{{L}^{2}}{{( 2 π )}^{2}} 2 πβ \frac{{n}_{eff \text{-} g}}{ℏ c} d E = \frac{{L}^{2}}{2 π} \frac{{n}_{eff} {n}_{eff \text{-} g}}{{ℏ}^{2} {c}^{2}} E d E$$

and the spontaneous emission rate is then given, for an atom at a particular location (x,y,z), by the quantity

$${W}_{b a \text{-} spont} = ( \frac{{πω}_{b a}}{{ɛ}_{0}} ) \frac{{L}^{2}}{2 π} \frac{{n}_{eff} {n}_{eff \text{-} g}}{{ℏ}^{2} {c}^{2}} E {μ}_{b a}^{2} \frac{1}{{L}^{2}} {\vert \hat{ρ} \cdot {ϕ}_{n}^{*} ( x ) \vert}^{2}$$

$$or$$

$${W}_{b a \text{-} spont} = \frac{{n}_{eff} {n}_{eff \text{-} g} {ω}_{b a}^{2} {μ}_{b a}^{2}}{2 ℏ {c}^{2} {ɛ}_{0}} {\vert \hat{ρ} \cdot {ϕ}_{n}^{*} ( x ) \vert}^{2}$$

If we suppose that the direction of \hat{ρ} is random, we average the dot product to get an additional factor of ⅓, yielding

$$〈 {W}_{b a \text{-} spont} 〉 = \frac{{n}_{eff} {n}_{eff \text{-} g} {ω}_{b a}^{2} {μ}_{b a}^{2}}{6 ℏ {c}^{2} {ɛ}_{0}} {\vert {ϕ}_{n} ( x ) \vert}^{2}$$

If we compare this rate to the total rate into free space (in a medium of index n, taken to be the same value as that of the material within the waveguide in which the atom is resident in the waveguide) we have

$$〈 \frac{{W}_{ba \text{-} spont \text{-} 1 D \text{-} slab \text{-} mode}}{{W}_{ba \text{-} spont \text{-} freespace}} 〉 = \frac{{n}_{eff} {n}_{eff \text{-} g} {ω}_{b a}^{2} {μ}_{b a}^{2}}{6 ℏ {c}^{2} {ɛ}_{0}} {\vert {ϕ}_{n} ( x ) \vert}^{2} \cdot {( \frac{{μ}_{b a}^{2} n {ω}_{b a}^{3}}{3 {πɛ}_{0} ℏ {c}^{3}} )}^{- 1} = \frac{π c}{2 {ω}_{b a}} \frac{{n}_{eff} {n}_{eff \text{-} g}}{n} {\vert {ϕ}_{n} ( x ) \vert}^{2}$$

$$or$$

$$〈 \frac{{W}_{ba \text{-} spont \text{-} 1 D \text{-} slab \text{-} mode}}{{W}_{ba \text{-} spont \text{-} freespace}} 〉 = \frac{1}{2} ( \frac{λ}{2 n} ) {n}_{eff} {n}_{eff \text{-} g} {\vert {ϕ}_{n} ( x ) \vert}^{2}$$

We can re-write this as

$$〈 \frac{{W}_{ba \text{-} spont \text{-} 1 D \text{-} slab \text{-} mode}}{{W}_{ba \text{-} spont \text{-} freespace}} 〉 = \frac{1}{2} ( \frac{λ}{2 n} ) \frac{{n}_{eff}}{n} \cdot \frac{1}{{t}_{eff}}$$

where the effective thickness of the vertical mode for an atom at position x is defined by

t_{eff}≡[nn_{eff-g}|φₙ(x)|²]⁻¹

Emission into a Channel Guide Mode

As another particular application of this, we can repeat this calculation and consider the spontaneous emission rate into a channel guided mode in a waveguide of length L. If the waveguide is terminated and we think of discrete frequencies for the longitudinal modes ωₗ, we can represent this mode by

Aₙ(x)=Ae^{iβ}^{ₙ}^{z}·φₙ(x,y)

where

$$A = \sqrt{\frac{1}{{ɛ}_{0} L}}$$

and if we again impose periodic boundary conditions, we have βₙ≡βₙ(ωₗ)=l·2π/L with l=0, ±1, ±2, . . . . Here φₙ(x,y) is the vector lateral field solution for the waveguide mode designated by n, containing all of its polarization and spatial characteristics, normalized to satisfy

$${\int }_{- ∞}^{∞} d x {\int }_{- ∞}^{∞} d y {ɛ}_{r} ( x , y ) {ψ}_{n}^{*} ( x , y ) \cdot {ψ}_{n} ( x , y ) = 1$$

In this case the density of states stems from

$$ρ ( {β}_{{z}_{n}} ) d {β}_{{z}_{n}} = \frac{L}{( 2 π )} d {β}_{{z}_{n}}$$

$$and again$$

$${β}_{{z}_{n}} = \pm \frac{{n}_{eff} ω}{c}$$

Here since we can have emission into the forward or reverse direction, we have two possible values and the resulting density of states is then

$$ρ ( ω ) = 2 \cdot \frac{L}{( 2 π )} \cdot \frac{{n}_{eff \text{-} g}}{c}$$

which is the same result we would get if we used instead a density of standing waves with a mode spacing of Δv=c/2n_{eff-g}L.

$$ρ ( E ) = 2 \cdot \frac{L}{( 2 πℏ )} \cdot \frac{{n}_{eff \text{-} g}}{c}$$

and the spontaneous emission rate is then given, for an atom at a particular location (x,y,z), by the quantity

$${W}_{ba \text{-} spont} = ( {πω}_{ba} ) \frac{1}{2 πℏ} \frac{2 {n}_{eff \text{-} g} L}{c} {μ}_{ba}^{2} \frac{1}{{ɛ}_{0} L} {\vert \hat{ρ} \cdot {ψ}_{n}^{*} ( x , y ) \vert}^{2}$$

$$or$$

$${W}_{ba \text{-} spont} = \frac{{n}_{eff \text{-} g} {ω}_{ba} {μ}_{ba}^{2}}{ℏ c {ɛ}_{0}} {\vert \hat{ρ} \cdot {ψ}_{n}^{*} ( x , y ) \vert}^{2}$$

If we suppose that the direction of \hat{ρ} is random, we average the dot product to get an additional factor of ⅓, yielding

$$〈 {W}_{ba \text{-} spont} 〉 = \frac{{n}_{eff \text{-} g} {ω}_{ba} {μ}_{ba}^{2}}{3 ℏ c {ɛ}_{0}} {\vert {ψ}_{n} ( x , y ) \vert}^{2}$$

If we compare this rate to the total rate into free space (in a medium of index n, taken to be the same value as that of the material within the waveguide in which the atom is resident in the waveguide) we have

$$\begin{matrix}〈 \frac{{W}_{ba \text{-} spont \text{--} channel \text{-} mode}}{{W}_{ba \text{-} spont \text{-} freespace}} 〉 = \frac{{n}_{eff \text{-} g} {ω}_{ba} {μ}_{ba}^{2}}{3 ℏ c {ɛ}_{0}} {\vert {ψ}_{n} ( x , y ) \vert}^{2} \cdot {( \frac{{μ}_{ba}^{2} {nω}_{ba}^{3}}{3 {πɛ}_{0} ℏ {c}^{3}} )}^{- 1} \\ = \frac{π {c}^{2}}{{ω}_{ba}^{2}} \frac{{n}_{eff \text{-} g}}{n} {\vert {ψ}_{n} ( x , y ) \vert}^{2}\end{matrix}$$

$$or$$

$$〈 \frac{{W}_{ba \text{-} spont \text{--} channel \text{-} mode}}{{W}_{ba \text{-} spont \text{-} freespace}} 〉 = \frac{1}{π} {( \frac{λ}{2 n} )}^{2} {n}_{eff \text{-} g} n {ψ}_{n}^{*} ( x , y ) \cdot {ψ}_{n} ( x , y )$$

Similarly to the one-dimensional case, we can re-write this as

$$〈 \frac{{W}_{ba \text{-} spont \text{--} channel \text{-} mode}}{{W}_{ba \text{-} spont \text{-} freespace}} 〉 = \frac{1}{π} {( \frac{λ}{2 n} )}^{2} \frac{1}{{A}_{eff}}$$

where the effective area of the channel guide mode for at atom at a position (x,y) is now defined by

A_{eff}≡[n_{eff-g}n|ψₙ(x,y)|²]⁻¹

If, as an example, we focus on a particular case where the waveguide is very tightly guided in the vertical (x) direction, but is more weakly guided in the lateral (y) direction. In this case, we can imagine that the first one-dimensional slab calculation will give a reasonably accurate figure for the total spontaneous radiation into the slab waveguide,

$$〈 \frac{{W}_{ba \text{-} spont \text{-1} \text{D-slab} \text{-} mode}}{{W}_{ba \text{-} spont \text{-} freespace}} 〉 = \frac{1}{2} ( \frac{λ}{2 n} ) {n}_{eff} {n}_{eff \text{-} g} {ϕ}_{n}^{*} ( x ) \cdot {ϕ}_{n} ( x )$$

We can then consider what fraction of that emission goes into the channel guided mode, which we would expect to be given approximately by

$$\begin{matrix}〈 \frac{{W}_{ba \text{-} spont \text{--} channel \text{-} mode}}{{W}_{ba \text{-} spont \text{-} 1 D \text{-} slab \text{-} mode}} 〉 = \frac{\frac{1}{π} {( \frac{λ}{2 n} )}^{2} {n}_{eff \text{-} g} n {ψ}_{n}^{*} ( x , y ) \cdot {ψ}_{n} ( x , y )}{\frac{1}{2} ( \frac{λ}{2 n} ) {n}_{eff} {n }_{eff \text{-} g} {ϕ}_{n}^{*} ( x ) \cdot {ϕ}_{n} ( x )} \\ = \frac{2}{π} \frac{n}{{n}_{eff}} ( \frac{λ}{2 n} ) \frac{{ψ}_{n}^{*} ( x , y ) \cdot {ψ}_{n} ( x , y )}{{ϕ}_{n}^{*} ( x ) \cdot {ϕ}_{n} ( x )}\end{matrix}$$

If we approximate the two-dimensional modal function as the product of the tight vertical mode φₙ(x) and a weaker lateral mode shape ξₙ(y) (as determined by the effective index method, for example) we would then have

ψₙ(x,y)≈φₙ(x)ξₙ(y)

where ξₙ(y) is simply normalized as

$${\int }_{- ∞}^{∞} {ξ}_{n}^{*} ( y ) \cdot {ξ}_{n} ( y ) d y = 1$$

(we rather arbitrarily choose to normalize this weaker lateral mode profile without the weighting function, which is used instead in the normalization of φₙ(x)). In this case, we would expect that the fraction of slab-guided spontaneous emission into the channel-guided waveguide mode might be approximately given by

$$〈 \frac{{W}_{ba \text{-} spont \text{--} channel \text{-} mode}}{{W}_{ba \text{-} spont \text{-} 1 D \text{-} slab \text{-} mode}} 〉 \approx \frac{2}{π} ( \frac{λ}{2 {n}_{eff}} ) \cdot {\vert {ξ}_{n} ( y ) \vert}^{2}$$

For a very approximate evaluation of this, if we consider a ridge waveguide with a width of W˜0.7 μm, and approximate ξₙ(y) with an ad-hoc form such as ξₙ(y)˜B cos(πy/2W) for |y|≦W and zero outside of this range, then at y=±0.35 μm, the intensity of the mode is ˜½ of peak. In this case we also have B˜W⁻¹. Since the effective index of the TM mode is n_{eff}˜2, we would have at 1.55 μm

$$〈 \frac{{W}_{ba \text{-} spont \text{--} channel \text{-} mode}}{{W}_{ba \text{-} spont \text{-} 1 D \text{-} slab \text{-} mode}} 〉 \approx 35 \%$$

at the peak of the mode amplitude, with an average across the mode of ˜30% across the active area. Note that more tightly confined lateral guides with widths W smaller than the assumed 0.7 μm would correspondingly have a larger fraction.

Note that the results above suggest that in circumstances where the spontaneous emission rate is in fact dominated by the combined emission into the slab radiation modes and the channel guided mode, that the actual emission efficiency into the channel-guided mode could be in the 30% range. If we recall the expression for the emission rate into the slab waveguide mode compared to the homogeneous medium “free space” result, we had

$$〈 \frac{{W}_{ba \text{-} spont \text{-} 1 D \text{-} slab \text{-} mode}}{{W}_{ba \text{-} spont \text{-} freespace}} 〉 = \frac{1}{2} ( \frac{λ}{2 n} ) \frac{{n}_{eff}}{n} \cdot \frac{1}{{t}_{eff}}$$

Because this can be a number which is much larger than unity, we might expect the spontaneous emission rate into the 1-dimensional slab waveguide mode to dominate the entire emission and the slab waveguide mode efficiency to be nearly 100%. In this case the 30% estimate above into the channel mode (or larger for smaller W) would be a good approximation of the total channel waveguide efficiency.

### Note on Normalization

With regard to normalization of the waveguide modes, it is instructive to look at the factor n_{eff-g}n|ψ(x,y)|² for the waveguide configurations which we see plays a central importance in the spontaneous emission rate through its appearance as

A_{eff}≡[n_{eff-g}n|ψₙ(x,y)|²]⁻¹

Since the electric field associated with Aₙ is simply proportional to Aₙ, the factor n_{eff-g}n|ψₙ(x,y)|² can also we written then as

$${n}_{eff - g} n {\vert {ψ}_{n} ( x , y ) \vert}^{2} = \frac{{n}_{eff - g} {nE}_{n}^{*} ( x , y ) \cdot {E}_{n} ( x , y )}{{\int }_{A} {n}^{2} ( x , y ) {E}_{n}^{*} ( x , y ) \cdot {E}_{n} ( x , y ) d x d y}$$

where A is shorthand for the lateral integration space. If we compare with the usual weighting factor for index changes that we would derive from classical waveguide theory, we would note that for small index changes Δn(x) this has the form

$$Δ {n}_{eff} = {\int }_{A} Δ n ( x , y ) \cdot f ( x , y ) d x d y$$

$$where$$

$$f ( x , y ) = \frac{2 c {ɛ}_{o} n ( x , y ) {E}_{n}^{*} ( x , y ) \cdot {E}_{n} ( x , y )}{{\int }_{A} ( {E}_{n} \times {H}_{n}^{*} + {E}_{n}^{*} \times {H}_{n} ) \cdot \hat{z} d x d y}$$

To explore the compatibility of these weighting factors, we note that the n(x) in the numerator is the same as the n of the material embedding the emitter and the numerators are the same except for the respective factors of n_{eff} and 2c∈ₒ. We are thus led to consider the relative magnitudes of

$$\frac{1}{2 c {ɛ}_{o}} {\int }_{A} ( {E}_{n} \times {H}_{n}^{*} + {E}_{n}^{*} \times {H}_{n} ) \cdot z d x d y$$

$$and$$

$$\frac{1}{{n}_{eff - g}} {\int }_{A} {n}^{2} ( x , y ) {E}_{n}^{*} ( x , y ) \cdot {E}_{n} ( x , y ) d x d y$$

Given that we can rigorously show the equal energy density of electric field and magnetic field contributions for the waveguide, we can multiply each side by c∈ₒ and we see that the equivalence of these two expressions is nothing more than a statement of the Poynting theorem with the Poynting vector on the left, and the waveguide group velocity times the integrated energy density on the right. These quantities are thus indeed identical, and we can use either weighting function to get the same result.

### Comparison to the Purcell Factor

The Purcell factor was presented as resulting from a resonator, and is cast in terms of the spontaneous emission rate enhancement due to the very high density of states at the resonance as captured by the resonator Q value. The factor is given by

$$F = \frac{6}{{π}^{2}} {( \frac{λ}{2 n} )}^{3} \frac{Q}{V}$$

However, the basis for this effect can better be viewed as resulting from the anomalously large amplitude of the modal field in such a resonator, and correspondingly, the anomalously large amplitude of the vacuum field fluctuations that can be viewed as being responsible for the spontaneous emission. The spontaneous emission changes we have seen in the waveguide are due to this exact same phenomenon. To see this explicitly, we can very easily extend the waveguide treatment to include a resonator, and get the Purcell ratio above.

As stated above, rather than viewing the Purcell effect as arising from an increase in the density of states, we will embed the resonator in a volume large enough such that the phase variance upon transmitting through the resonator does not significantly effect the density of states of the large volume, even at the resonant frequency. We will show here that this same requirement on the size of the large volume is also sufficient to guarantee that the energy inside the resonator, while possibly large at resonance, is still vanishingly small compared to the energy outside the resonator in the large volume. This means that the large volume modes can still be used without changing their normalization to the large volume, and the density of states is also unchanged for these modes.

In this picture, the Purcell effect arises entirely from the increased amplitude of the modes inside the resonator and is not related to any change in the density of states.

As a simple illustration of this, we can consider the two-dimensional channel waveguide, and we already know that the spontaneous emission rate into such a waveguide is given by

$${W}_{ba - spont} = \frac{{n}_{eff - g} {ω}_{ba} {μ}_{ba}^{2}}{ℏ c {ɛ}_{0}} {\vert \hat{ρ} \cdot {ψ}_{n}^{*} ( x , y ) \vert}^{2}$$

where we have not averaged over angles of the atomic dipole moment. If we place two reflectors of power reflectivity R in this waveguide separated by a length L_{c} this makes a small Fabry-Perot resonator of length L_{c} with the transmission characteristic given by

$${t}_{FP} ( ω ) = \frac{T {e}^{iβ {L}_{c}}}{1 - R \cdot {e}^{i2β {L}_{c}}}$$

and if we let R=1−δ where δ is understood to be small, we obtain the power transmission of the mirror as T=∈ and the Q of the resonator is given by

$$Q = \frac{{L}_{c} {n}_{eff - g} ω}{c δ}$$

We now want to stipulate that the total external length of the waveguide L is so large that the number of external modes that “sample” the spectral width of the resonance for a mode in question is large. If we consider propagation along the z-axis as illustrated in the figure, the usual periodic boundary condition, or phase condition, for the modes of the huge cavity in the z direction would be

β(L−L_{c})+φᵣₑₛₒₙₐₜₒᵣ=2πM

and the number of modes in an interval d/β is then

$$dM = ( ( {L}_{z} - {L}_{c} ) + \frac{d {ϕ}_{resonator}}{d β} ) \frac{d β}{2 π}$$

We know that the resonator phase will vary rapidly in the region of the resonance, so to significantly oversample the resonance, we must require that, even in the vicinity of the resonance,

$$\frac{d {ϕ}_{resonator}}{d β} << ( {L}_{z} - {L}_{c} )$$

At resonance, it is easy to calculate the phase derivative above, and we have

$$\frac{d {ϕ}_{resonator}}{d β} = \frac{2 cQ}{{n}_{eff - g} ω}$$

So to have a high density of external modes to smoothly and effectively sample through the resonance we need

$$Q = \frac{{L}_{c} {n}_{eff - g} ω}{c δ} << \frac{{n}_{eff - g} ω ( L - {L}_{c} )}{2 c}$$

which says that we just need to be sure that L>>2L_{c}/δ which is easy to do mathematically, recalling that L is just the large, otherwise arbitrary dimension of our waveguide. We also want to stipulate that the normalization of the long waveguide modes is not impacted by the presence of the resonator. Note that this normalization is given by

$${\int }_{L} d z {\int }_{A} {n}^{2} {\vert {A}_{n} \vert}^{2} \cdot d x d y = 1$$

where A covers the area of the lateral mode and L is the very long external length of the waveguide. Because |Eₙ|²∝|Aₙ|², clearly if the overall normalization is not impacted we would require that the integrated value of |Eₙ|² inside the resonator (i.e., the energy) is negligibly small compared to the total integrated value of |Eₙ|² along the entire length of the waveguide. To compute this, we need to evaluate the field enhancement of an external mode that is coupled into the resonator. The ratio of the field outside to the field inside is simply given by

$$\frac{{E}_{out}}{{E}_{in}} = \sqrt{T} = \sqrt{δ}$$

Thus the energy density outside compared to the energy density inside will be proportional to

$$δ = \frac{{L}_{c} {n}_{eff - g} ω}{cQ} .$$

Then if the energy density inside is U the energy density outside is

$$U \frac{{L}_{c} {n}_{eff - g} ω}{cQ} ,$$

and we require for negligible energy in the resonator

$$U \cdot {L}_{c} << U \frac{{L}_{c} {n}_{eff - g} ω}{cQ} L$$

which thus requires that

$$L >> \frac{cQ}{{n}_{eff - g} ω} or L >> \frac{{L}_{c}}{δ}$$

which we see is the identical condition we needed to make sure the phase distortion of the resonator transmission was not strong enough to impact the sampling of the resonance feature with many external long waveguide modes.

From this point, the enhancement inside the resonator is obvious because the long waveguide modes normalization is unaffected, and the density of states is identical to what we have already used to calculate spontaneous emission into the waveguide modes.

The only difference is the fact that the amplitude of the electric field locally inside the mode is now larger by a factor as noted above,

$$\frac{{E}_{in}}{{E}_{out}} = \frac{1}{\sqrt{δ}}$$

and since the spontaneous rate scaled as |Eₙ(x,y)|² the spontaneous rate is just increased by exactly a factor of

$$\frac{{W}_{sp - resonator}}{{W}_{sp - channel - guide}} = \frac{1}{δ} = \frac{cQ}{{L}_{c} {n}_{eff - g} ω} .$$

Referring to our previous calculation of spontaneous emission rate into the channel waveguide mode, we then have our result for the enhancement of spontaneous emission inside the resonator, as compared to free space, as being

W_{ba-spont-res}=W_{ba-spout-channel-guide}×(Waveguide Resonator Enhancement)

or

$${W}_{ba - spont - res} = \frac{{n}_{eff - g} {ω}_{ba} {μ}_{ba}^{2}}{ℏ c {ɛ}_{0}} {\vert \hat{ρ} \cdot {ψ}_{n}^{*} ( x , y ) \vert}^{2} \cdot ( \frac{cQ}{{L}_{c} {n}_{eff - g} ω} )$$

and the ratio to the free space spontaneous emission rate is then

$$\frac{{W}_{ba - spont - res}}{{W}_{ba - spont - free - space}} = \frac{cQ}{{L}_{c} {n}_{eff - g} ω} \cdot \frac{{n}_{eff - g} {ω}_{ba} {μ}_{ba}^{2}}{ℏ c {ɛ}_{0}} {\vert \hat{ρ} \cdot {ψ}_{n}^{*} ( x , y ) \vert}^{2} \cdot {( \frac{{μ}_{ba}^{2} n {ω}_{ba}^{3}}{3 {πɛ}_{0} ℏ {c}^{3}} )}^{- 1}$$

$$or$$

$$\frac{{W}_{ba - spont - res}}{{W}_{ba - spont - free - space}} = \tilde{F} = \frac{n}{{n}_{eff - g}} \frac{3}{{π}^{2}} {( \frac{λ}{2 n} )}^{3} Q \frac{1}{{L}_{c}} {nn}_{eff - g} {\vert \hat{ρ} \cdot {ψ}_{n}^{*} ( x , y ) \vert}^{2}$$

which we recognize as essentially the Purcell factor F quoted earlier when we equate

A_{eff}≡[n_{eff-g}n|ψₙ(x,y)|²]⁻¹

for at atom located inside the resonator at a position (x,y) to get

$$\tilde{F} = \frac{6}{{π}^{2}} {( \frac{λ}{2 n} )}^{3} Q \cdot \frac{n}{{n}_{eff - g}} \frac{1}{{V}_{eff}}$$

where for this purpose we have elected to set

$${V}_{eff} = {A}_{eff} \frac{{L}_{c}}{2} .$$

The additional factor of ½ arises here if we consider the position of the atom to be at the peak of a longitudinal standing wave inside the cavity rather than its average value along the cavity, as would be clear if the cavity was only half a wavelength long and we used the same method to define the cavity length as we have for the cavity area, and the factor of

$$\frac{n}{{n}_{eff - g}}$$

can be seen as a correction for dispersive effects.

### Back to Spontaneous Emission Rate Enhancement in Non-Resonant Waveguides

From the description thus far it is clear that there can be enhancement of the spontaneous emission rate into a 1-dimensional slab waveguide or a full channel waveguide if the ratios

$$〈 \frac{{W}_{ba - spont - 1 D - slab - mode}}{{W}_{ba - spont - freespace}} 〉 = \frac{1}{2} ( \frac{λ}{2 n} ) \frac{{n}_{eff}}{n} \cdot \frac{1}{{t}_{eff}}$$

$$〈 \frac{{W}_{ba - spont - channel - mode}}{{W}_{ba - spont - freespace}} 〉 = \frac{1}{π} {( \frac{λ}{2 n} )}^{2} \frac{1}{{A}_{eff}}$$

are larger than unity, where the effective thickness or area of the guide mode is defined for at atom at a position (x) or (x,y) by

t_{eff}≡[nn_{eff-g}|φₙ(x)|²]⁻¹ or A_{eff}≡[n_{eff-g}n|ψₙ(x,y)|²]⁻¹

for the 1-D slab or channel guide respectively.

In this case waveguides that provide a strong reduction in these factors t_{eff} or A_{eff} could also possibly provide for strong enhancements in the spontaneous emission rates relative to the case for a homogeneous medium.

Application using a Slot Waveguide Structure

It is precisely these factors that can be remarkably reduced in slot waveguide structures. To illustrate this we can look at the value of

$${t}_{eff}^{- 1} = \frac{2 c {ɛ}_{o} n ( x ) {E}_{n}^{*} ( x ) \cdot {E}_{n} ( x )}{{\int }_{T} ( {E}_{n} \times {H}_{n}^{*} + {E}_{n}^{*} \times {H}_{n} ) \cdot \hat{z} d x}$$

$$or$$

$${A}_{eff}^{- 1} = \frac{2 c {ɛ}_{o} n ( x , y ) {E}_{n}^{*} ( x , y ) \cdot {E}_{n} ( x , y )}{{\int }_{A} ( {E}_{n} \times {H}_{n}^{*} + {E}_{n}^{*} \times {H}_{n} ) \cdot \hat{z} d x d y}$$

where T and A are just shorthand for the relevant lateral integration ranges, for a typical air-Si—SiO₂—Si—SiO₂ slot waveguide structure. Cross section of an exemplary narrow slot waveguide using a weakly guided lateral ridge structure. FIG. 3 illustrates such a waveguide comprised of silicon layers with a thin 8 nm layer of SiO₂ between the layers. Waveguide is supported on a silicon substrate, separated from the substrate by a thick Buried Oxide (BOX) layer of SiO₂.

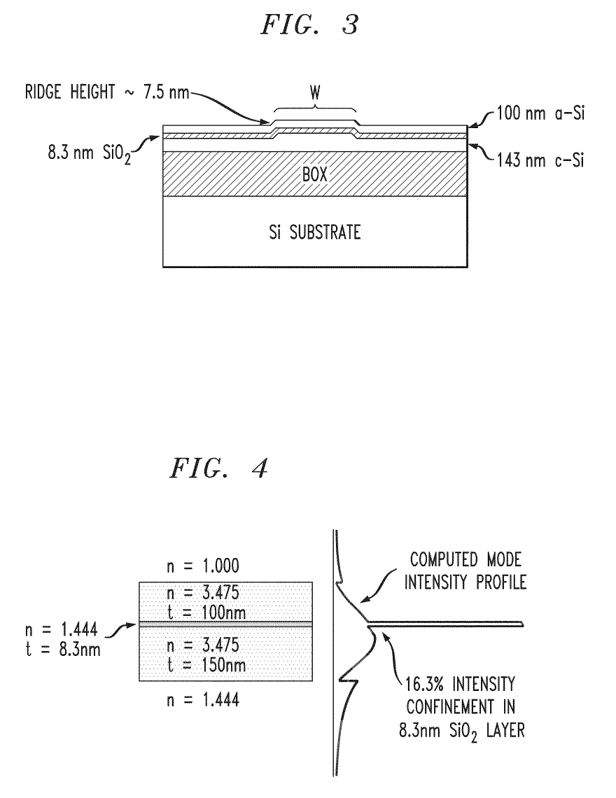

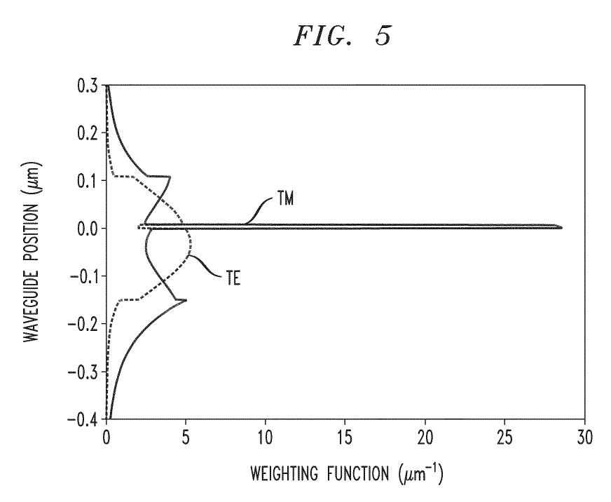

If we look at just the cross-section through the center of this structure and consider the equivalent 1-dimensional slab with identical layer thicknesses, we can calculate the effective thickness of the guide using the formalism above. The exemplary waveguide is shown in FIG. 4, which also includes a plot of the numerically evaluated modal intensity. The dimensions for this structure are 150 nm for the lower Si layer, 8.3 nm for the SiO₂ slot, and 100 nm for the upper Si layer. The indices of refraction are taken to be n_{SiO}_{₂}=1.444 and n_{Si}=3.475 at a wavelength of 1550 nm. FIG. 5 plots the inverse of the effective thickness for a species located at any particular vertical position for the structure for both the TE and TM mode. FIG. 5 illustrates that for the TM mode the effective thickness of the slot guide, for an excited species placed in the thin slot SiO₂ layer is only t_{eff} ˜35 nm. For the TE mode, the effective thickness is t_{eff}˜450 nm, >10× larger.

This leads to an enhancement of spontaneous emission into the TM slot waveguide mode, relative to emitting in homogeneous SiO₂, of by a factor of

$$〈 \frac{{W}_{ba - spont - 1 D - slab - mode}}{{W}_{ba - spont - freespace}} 〉 = \frac{1}{2} ( \frac{λ}{2 n} ) \frac{{n}_{eff}}{n} \cdot \frac{1}{{t}_{eff}} \sim 10.6$$

If the polarization of the emitter were chosen to match the polarization of the TM mode rather than be averaged by ⅓ over all directions, this result would be correspondingly 3 times larger, and would exceed 30.

In this process, we have considered emission enhancement into the waveguide modes but have neglected the fact that non-guided modes, or so-called “radiation modes” may also be enhanced. If this were to be significant, then while the spontaneous emission rate might be increased at least as much as discussed thus far, it could be increased even more. This, however, could have the detrimental effect that the final fraction of spontaneous emission into the waveguide mode would not be as large as might be desired.

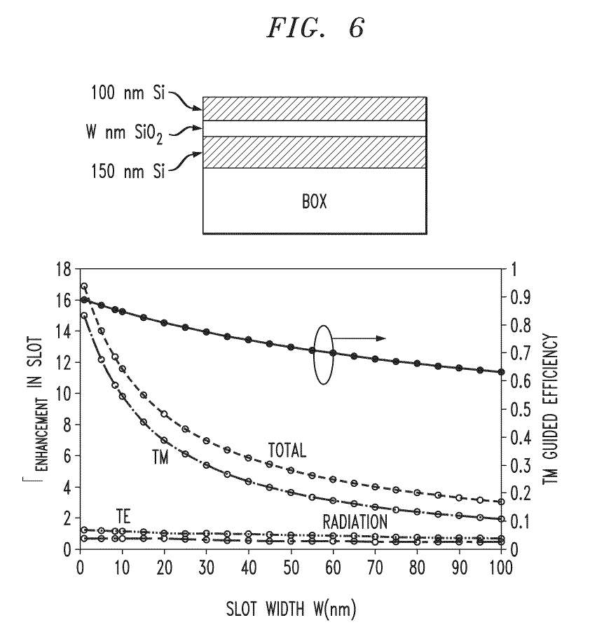

To calculate this effect, we must calculate the enhanced spontaneous emission rate for all the modes of the structure, including non-guided or radiation modes. The results of such numerical calculations are shown below in FIGS. 6, 7, 8 and 9.

FIG. 6 shows the enhancement of spontaneous emission rate Γ_{enhancement} is shown as a function of the SiO₂ slot width. The total enhanced rate is shown, including enhancement from the guided slot TM mode, the guided TE mode, and all the unguided or radiation modes. Also shown are the various components, including the enhancement due to just the guided TM mode. On the right is shown the percentage of the spontaneously emitted light that is emitted into the TM guided mode. It can be seen that for small slot widths, the ratio reaches 90%, indicating that indeed the guided TM slot mode with the very narrow effective thickness t_{eff} dominates the enhancement. Thus very high emission efficiency can indeed be expected into the guided TM mode in such a structure.

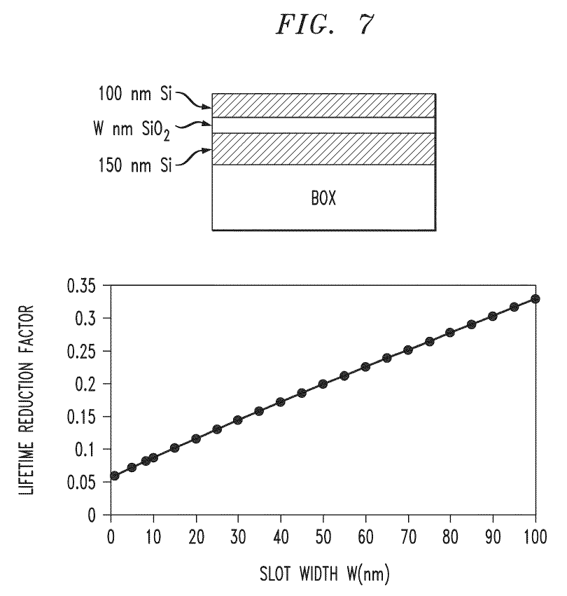

FIG. 7 shows the total spontaneous emission lifetime reduction factor as a function of the slot thickness. This very significant lifetime reduction can significantly improve modulation bandwidth and also emission efficiency if non-radiative decay paths are present

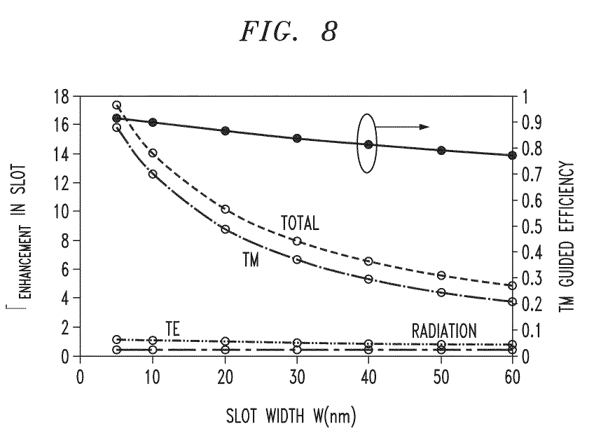

FIG. 8 shows the result of a similar calculation with slight change in Si layer thicknesses. In this case the waveguide is comprised of two identical Si layers with thicknesses of 140 nm each. Here the efficiency into the TM slot waveguide mode exceeds 90%

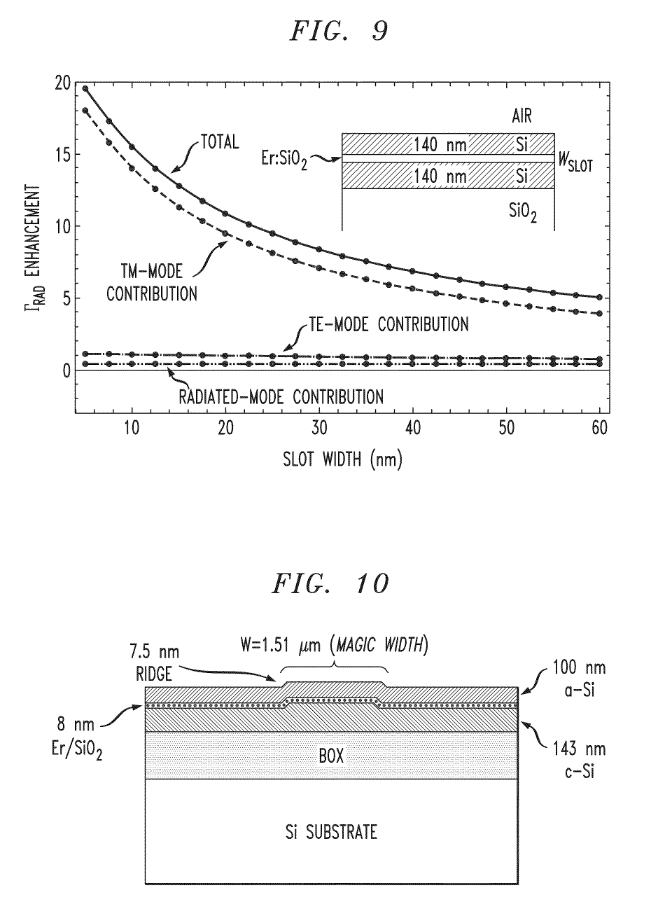

FIG. 9 shows the same calculation done by a slightly different numerical method providing additional verification for the magnitude of the effect.

These calculations establish that, even when including all the possible enhancements in spontaneous emission due to radiation modes, the spontaneous emission into the guided TM slot waveguide mode dominates the total emission rate and our expectations based upon the earlier analytic results are roughly correct.

FIG. 10 shows a slot waveguide sample we have experimentally already realized similar in structure to those described in the calculations presented thus far, and upon which we have conducted optical pumping experiments.

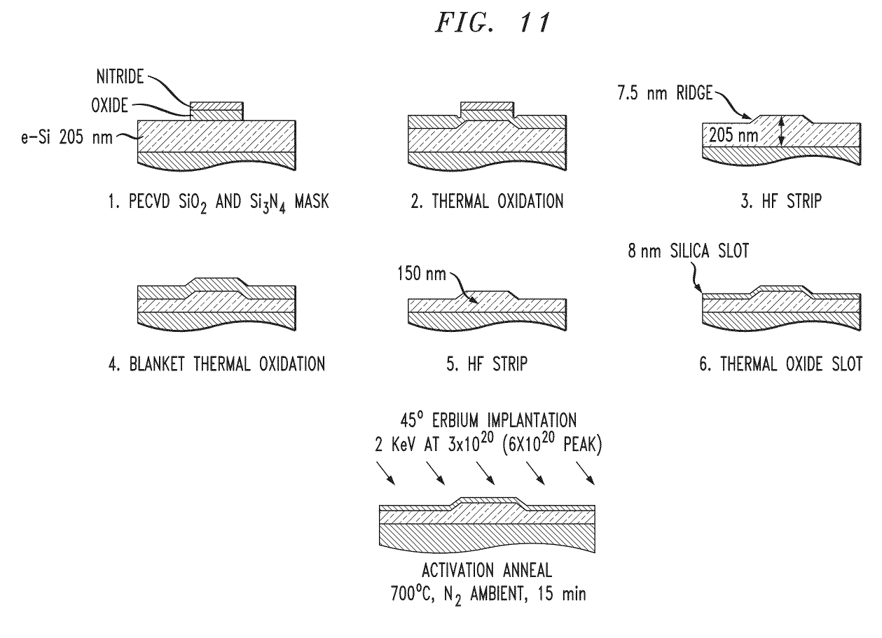

The fabrication sequence used to realize this sample is illustrated in FIG. 11. We used a sequence of PECVD SiO₂ and Si₃N₄ masking which then defines the waveguide core during a subsequent thermal oxidation step that forms an oxide and reduces the remaining thickness of the Si layer in the lateral cladding regions. After removing the mask materials during an HF strip, the lower layer of what will become the waveguide core is reduced to the desired thickness of 150 nm by a thermal oxidation step and subsequent HF stripping of the oxide. Then a precise SiO₂ slot waveguide layer is grown to a thickness of 8 nm with thermal oxidation. This layer is the implanted with Er ions at a very low energy and shallow, angled implant to provide the emitting species. The implant conditions were a 45° Erbium implantation at 2 KeV at with a dose of 3×10²⁰ cm⁻³ (6×10²⁰ cm⁻³ peak) in the 8 nm oxide layer. This was then given an activation anneal at 700° C. in a N₂ ambient for 15 minutes. Subsequently the upper layer of Si was deposited over the SiO₂ slot using H₂ pre-treatment and α-silicon deposition using plasma CVD.

These waveguides were also designed to be at the “magic width” where the inherent TM lateral radiation losses are cancelled out inteferometrically from the two lateral borders of the waveguide. The theory and experimental realization of this phenomena has been described in detail elsewhere. Because the slot waveguide enhancement is most dramatic for the TM mode, it may be important in some circumstances to combine the inventive device described herein with the magic width design principles. This may be true when the lowest loss waveguide are required, when weaker lateral guided is desired, or when lateral electrical access is desired with substantial conductivity pathways of higher index material as are provided by the lateral field regions of the ridge waveguide.

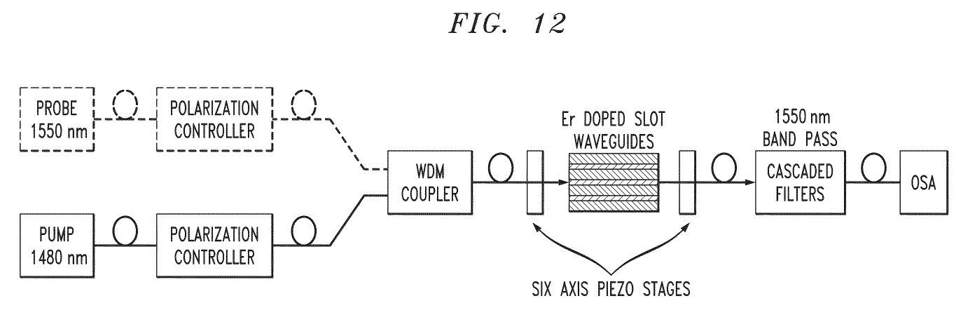

The experimental apparatus and the room temperature emission spectrum from this sample is shown in FIG. 12 and FIG. 13 when excited by a 1480 nm laser source coupled into the waveguide. FIG. 12 shows the detail of the optical pumping configuration for Er-doped slot waveguide emission experiment. FIG. 13 shows the emission as measured from the Erbium-doped slot waveguide under optical pumping with a sequence of pump powers coupled into the waveguide. Emission was predominantly TM emission as expected from enhancement of TM emission predicted from analysis.

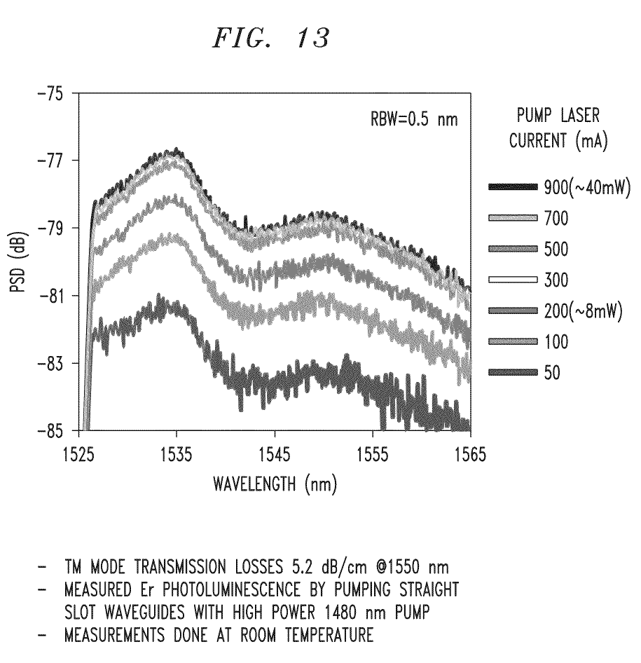

The time resolved emission from this sample has also been measured using a high-sensitivity preamplifier and a box-car integrating setup. The results for the emission decay are shown in FIG. 14, which illustrates the time resolved luminescence from optically pumped Erbium-doped slot waveguide sample. Optical pump is a rectangular pulse. Decay is observed with two different box-car gate integration times. The 15 μsec example has lower noise but forfeits time resolution required to resolve fast components of decay right at end of pump pulse. This component is resolved with the 1 μsec gate width.

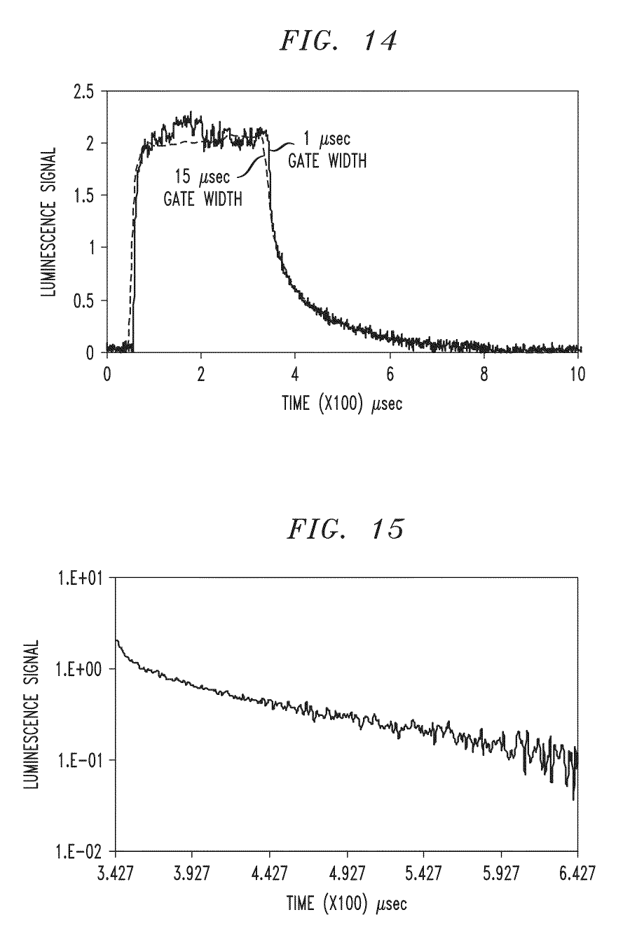

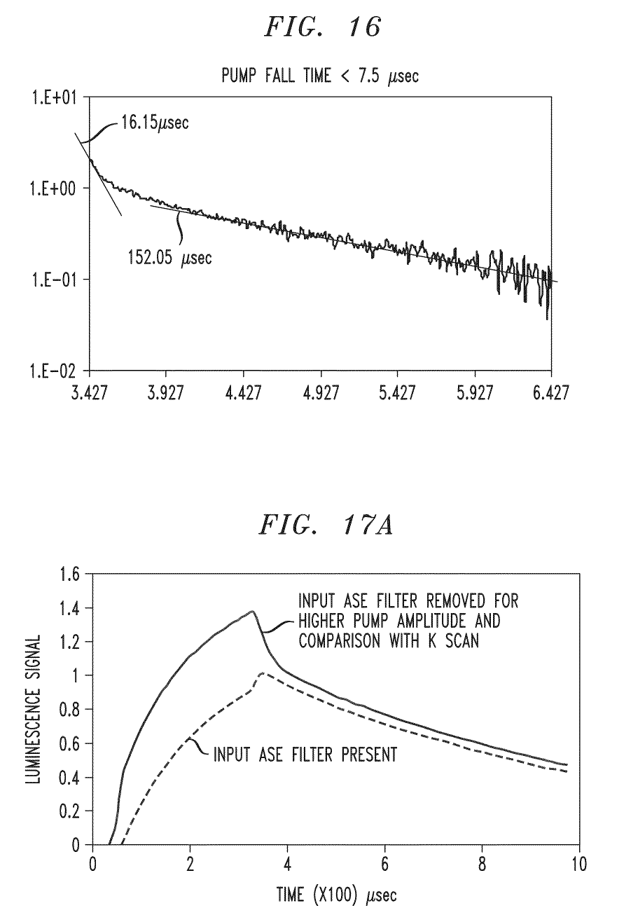

FIG. 15 shows the detail of decay with 1 μsec gate width. With the shorter integration time of 1 μsec, there is more noise but a faster components is resolved. This faster component is illustrated more clearly FIG. 16, which shows a fast components with a ˜16 μsec timescale, and then another much longer component with a time scale of ˜150 μsec. We believe that the shorter timescale is a non-radiative component that may be due to non-radiative recombination from the very high Er concentration in these samples, but may also be due to non-radiative energy transfer or de-excitation of the excited Er into the adjacent layers of Si that are only nm away. The longer decay of ˜150 μsec is believed to be impacted by the enhanced radiative emission predicted by the calculations. The longest component observed is ˜150 μsec, which is more than 10× lower than typical radiative Er lifetimes in SiO₂. This is further supported by a control sample with emission results that are shown in FIGS. 17(a) and 17(b). FIG. 17(a) shows spontaneous emission in response to a step function optical excitation, with and without an Amplified Spontaneous Emission (ASE) filter to bloc the spontaneous emission of the pump source. FIG. 17(b) illustrates the decay on a log scale, with a 736 μsec decay time. In this sample, there is no slot present but there is still a calculated spontaneous decay enhancement by a factor of 2.45, suggesting an equivalent homogeneous medium decay time of 1.8 msec.

The rapid decay observed in the slot sample could presumably also be sped up by additional non-radiative mechanism. However, the total integrated radiative luminescence emission power we collect from the waveguide sample is too large for this to due exclusively to non-radiative components. From simple rate equation, we should be able to invert Er with quite low optical pump power:

$${N}_{2} = {N}_{Er} \cdot \frac{{σ}_{abs} ( {λ}_{p} )}{{σ}_{em} ( {λ}_{p} ) + {σ}_{abs} ( {λ}_{p} )} \cdot \frac{1}{( 1 + \frac{1}{τ {v}_{g} {S}_{pump - slot} ( \begin{matrix}{σ}_{em} ( {λ}_{p} ) + \\ {σ}_{abs} ( {λ}_{p} )\end{matrix} )} )}$$

which yields >90% of possible inversion at pump wavelength when

$${P}_{coupled - pump} = 10 \cdot \frac{hv}{τ} \cdot \frac{{A}_{eff}}{[ {σ}_{em} ( {λ}_{p} ) + {σ}_{abs} ( {λ}_{p} ) ]}$$

If we assume τ˜5 ms (typical Er lifetime), and A_{eff}˜5×10⁻¹⁰ cm⁻³ for the 1.5 μm waveguide (t_{eff}=35 nm, W=1.5 μm), this requires only 20 μW of coupled power. From the data, it can be seen that the power required to achieve saturation is more than two orders of magnitude higher, suggesting much shorter lifetimes which appears to be consistent with the initial fast decay time. However, the emission power is only a factor of 10 below the expected value based upon 100% radiative emission efficiency. This suggests a nonradiative rate that is at least two orders of magnitude faster than the normal radiative rate, while the actual radiative rate is enhanced and is at least one order of magnitude faster than the usual radiative rate. We therefore believe that the combination of the time decay measured and the power collected in this data is generally consistent with the calculated expectation that we should indeed be observed enhanced spontaneous emission rates into the TM slot waveguide mode.

The implications of any dramatic enhancement of spontaneous emission rates into a designated waveguide mode that is capable of low-loss propagation are quite remarkable. The conclusion is that nearly all the spontaneous emission from an excited material, atomic species, or other spontaneously emitting source will go into a particular waveguide mode that can be subsequently used for applications such as communications, sensors, signal processing, or energy conversion. As noted earlier, it additionally means that the remarkable net rate increase in spontaneous emission may also increase the total radiative efficiency beyond what would be observed in a homogeneous medium if there are any detrimental competing background non-radiative recombination mechanisms. Finally, it also suggests that the source will be capable of modulation with bandwidths that are increased by large amounts. This modulation can be achieved by modulating the source of excitation, which can be optical or electrical as illustrated in the following examples.

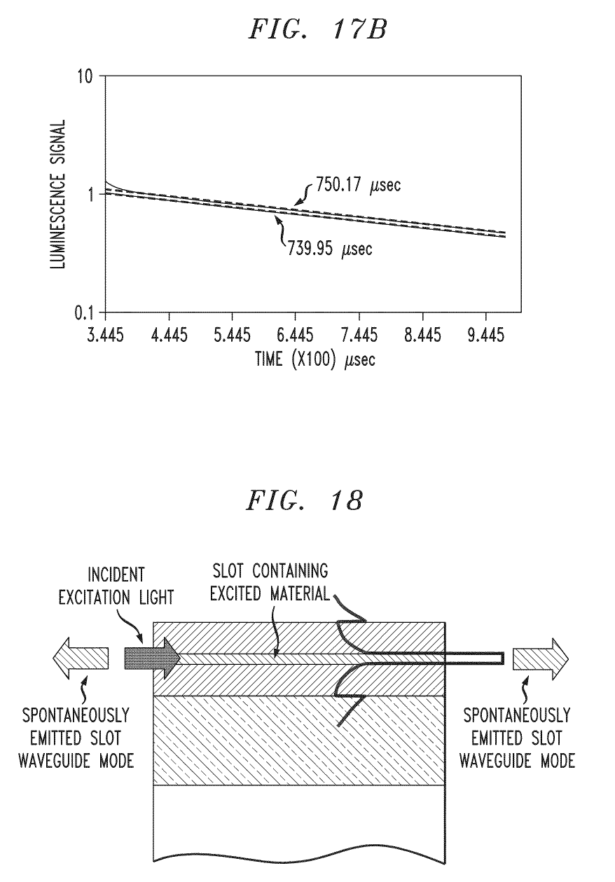

FIG. 18 shows an example of a device configuration allowing for optical excitation of a species in the slot medium, wherein the optical excitation source is injected into a mode of the optical waveguide. Optical excitation source could be modulated to modulate the spontaneous emission.

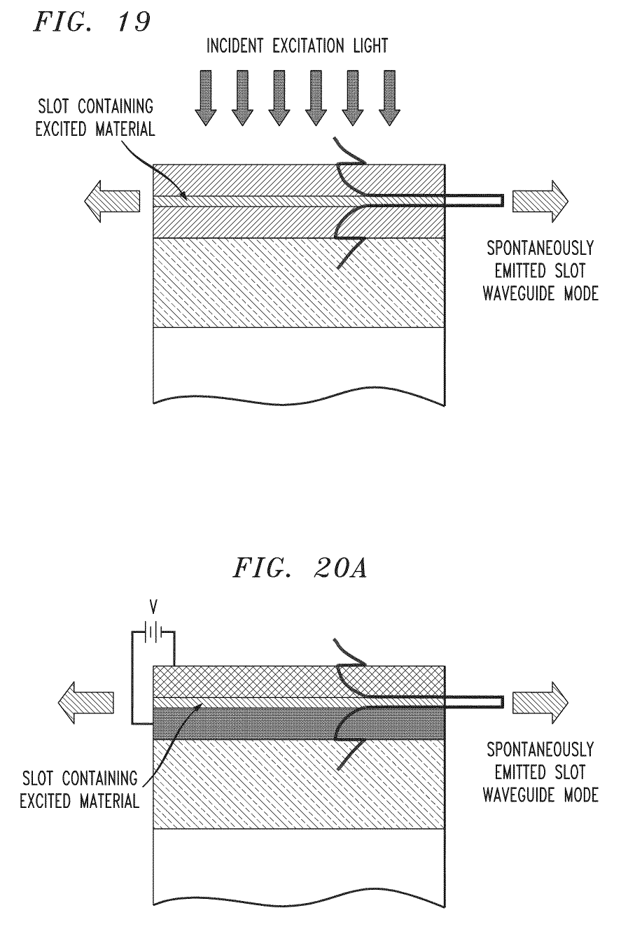

FIG. 19 shows an example of a device configuration allowing for optical excitation of a species in the slot medium, wherein the optical excitation source is impinging on the material in the slot waveguide through the waveguide layers. This includes the possibility of excitation from a light source external to the waveguide layers, such as might occur with solar radiation being absorbed by a species in the waveguide slot layer. Again the optical excitation source could be modulated to modulate the spontaneous emission.

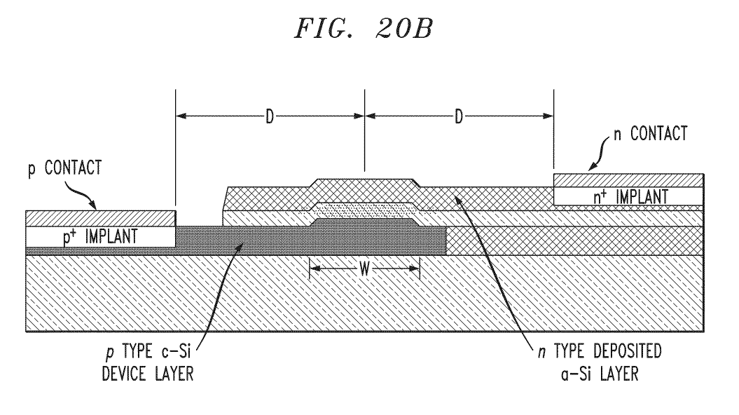

FIGS. 20(a) and 20(b) illustrates an example of an embodiment where the slot layer contains a dielectric with in impurity that can be excited by application of suitable electric fields across the dielectric. FIG. 20(a) shows a longitudinal view of spontaneous emission source. FIG. 20(b) shows a cross-section of exemplary lateral contacting scheme. The contacts are laterally separated from the core of the waveguide region to allow for low loss propagation without interference or absorption caused by the metals of the contacts, or the high doping often used to achieve low-resistance contacts. Typical dimension are the same as those described for the slot waveguide structure already, but laterall the dimensions of the waveguide would typically have Win the range of 0.25 μm to 5 μm, while the separation D to the contact layers would be typically 1 μm to 10 μm. These values could be considerably larger for wavelengths in the infrared or THz region, and are not intended to be restrictive. Here the electrical excitation source could be modulated to modulate the spontaneous emission. Techniques for applying electrical excitation to appropriate layers of an active optoelectronic device are well-known to those skilled in the art. They are found in many design alternatives for conventional spontaneous light emitting devices such as LEDs, and also in varies forms of semiconductor lasers and optical modulators. The FIGS. 20(a) and 20(b) are merely intended to be exemplary of such designs, and it is understood that many well-known means can be applied to create electrical excitation in the slot layer of novel devices designed according to the teachings of the present invention.

FIG. 21 illustrates an example of a device configuration allowing for parametric fluorescence, where the material in the slot is a nonlinear medium and the parametric fluorescence arises from nonlinear mixing of optical signals propagating in the waveguide. The parametric fluorescence is a form of spontaneous emission that will be enhanced in the same manner as described herein. Here again the optical excitation source could be modulated to modulate the spontaneous emission.

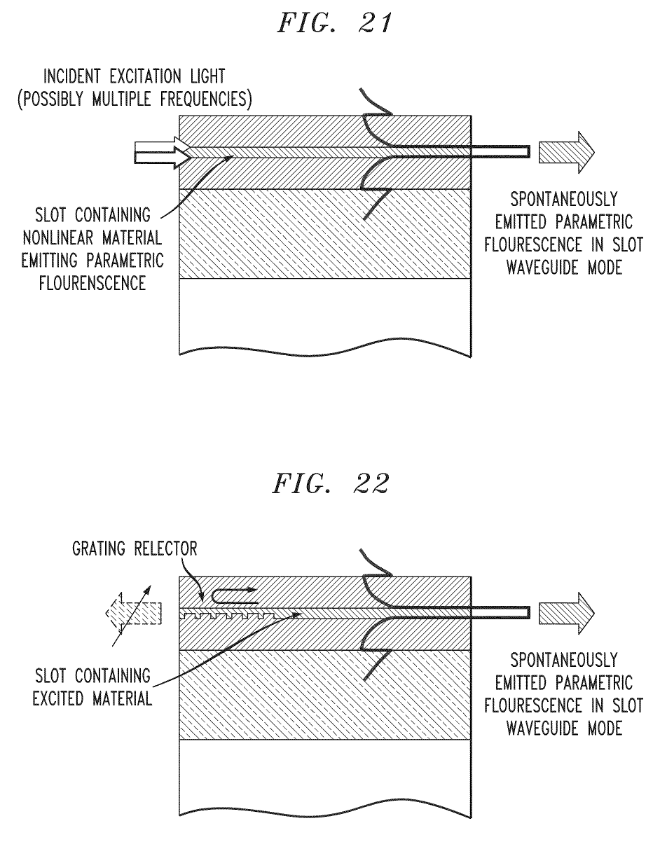

FIG. 22 illustrates an exemplary inclusion of a reflector in the waveguide to channel all the spontaneous emission into a single direction in the waveguide. This reflector configuration can be applied to any of the device configurations described above. The reflector can be realized with a mirror, or a Bragg or grating-based reflector, or any means to reverse the direction of propagation of light traveling in the waveguide.

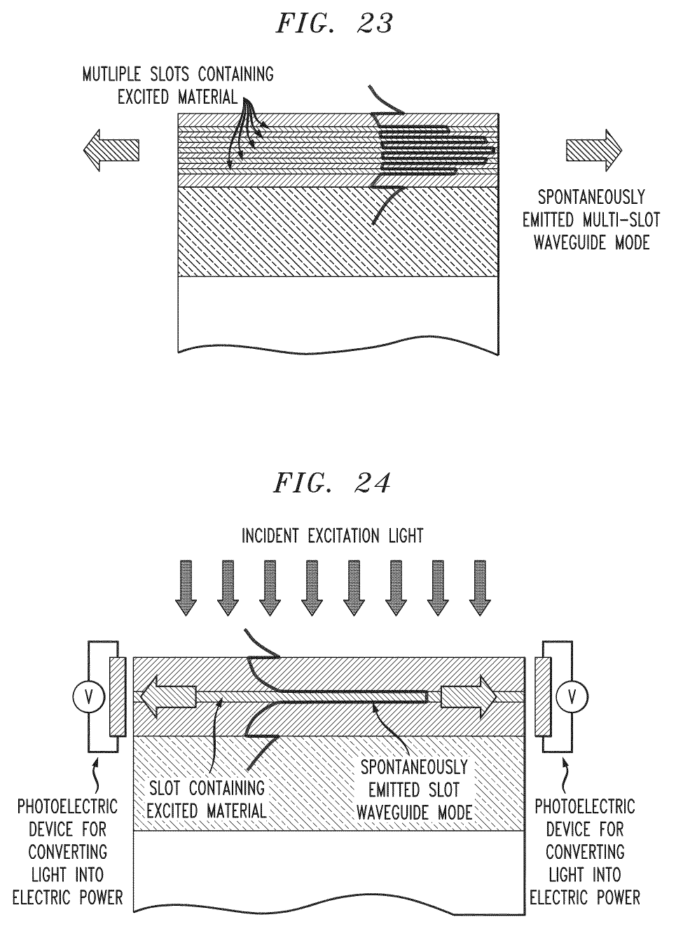

FIG. 23 illustrates an exemplary inclusion of multiple slots in the waveguide. Such a structure will not markedly change the spontaneous emission efficiency into the waveguide mode for any particular emitting excited species, but it can lead to net increases in emitted power or net increases in excitation efficiency for different exciting methods. This structure can be applied to any of the examples illustrated thus far, and others not illustrated.

FIG. 24 illustrates an exemplary system where light that is absorbed and then preferentially emitted into the slot waveguide mode with high efficiency is subsequently converted to useful electrical energy by including a photoelectric conversion device at the edge of the waveguide system. Such devices include junction solar cells or junction photodiodes, but may also include other conversion devices well known to those skilled in the art. Additionally, rather than the photoelectric conversion device illustrated in the figure, the device at the edge of the waveguide could include a thermal conversion device wherein the light preferentially emitted into the waveguide mode is absorbed and turned into heat in the device at the edge of the waveguide. The heat is then subsequently used for conversion to useful energy using techniques well known to those skilled in the art.

The slot waveguide calculations shown here are for illustrative purposes and serve to confirm that dramatic enhancements in spontaneous emission rates and high efficiency into particular waveguide modes can indeed be achieved with typical parameters that are readily achieved in the laboratory or using CMOS processing techniques. They are, however, only exemplary embodiments and are not meant to be restrictive or to limit the scope of this invention.

This invention is distinguished quite markedly from earlier published work on enhanced spontaneous emission since it does not utilize an optical gain medium, does not utilize a resonator, and does not utilize any plasmonic or metal clad structures or waveguides. Instead, this enhancement is realized in slot waveguide structures which have been fabricated with very low propagation losses demonstrated below 2 dB/cm. The increase in spontaneous emission rates have very advantageous benefits in increasing efficiency and modulation bandwidth, and offer the possibility of broadband, incoherent sources that are very attractive or essential for many applications. We have shown that the efficiency of generated light into the guided mode can reach at least to the level of ˜95%. We have shown that the radiative rates can increase by amounts in excess of 30× for polarized emitters, or amounts in excess of 10× for randomly polarized emitters. This will lead to very significant de-emphasis of any non-radiative decay rates, thereby improving efficiency. It will also lead to high modulation bandwidths while maintaining high efficiency.

While silicon is used in the calculations for the layers adjacent to the slot for purposes of illustration, it is anticipated that other materials could be used for the layers adjacent to the slot. These could include other semiconductors such as Ge, as well as many compound semiconductors including, but not limited to, GaAs, AlₓGaₓAs, InP, InₓGaₗ₋ₓAs, InₓGaₗ₋ₓAs_{y}P_{l-y}, InₓAlₗ₋ₓAs, InₓAl_{y}Ga_{l-x-y}As, GaN, AlₓGaₗ₋ₓN, AlN, GaSb. These layers could also comprise other non-semiconductor dielectrics. The index of refraction of these layers is anticipated to provide useful enhancements in keeping with the teachings of this invention when it has any value in excess of the index of the slot material. For more typical slot materials, including liquids and lower index dielectrics, the layers adjacent to the slot would preferentially have index values of n˜1.5 or greater, and the large enhancements illustrated in the embodiments show cases where the index of the material adjacent to the slot is n>2.0. Particular calculations were shown for index values of n=3.475. The thickness of these layers serves to provide the primary waveguiding high index core, and the thickness of these layers could be in a wide range depending on whether or not it is critical to have emission into a single fundamental mode of the waveguide or not. The example used for illustration was single-mode and each layer had dimensions of 0.14 μm or less, chosen to provide optimized results. However, for wavelengths longer than these layers can be thicker and for longer wavelength or lower index materials be even significantly thicker while still maintaining single mode behavior. The thicknesses are generally expected to be below 5 μm each for the near infrared region of the spectrum λ<2.5 μm, but could extend to 20 μm or more for infrared and THz applications.

The slot in the slot waveguide structure could have dimensions ranging from monolayer atomic dimensions of 0.1 nm to as large as 1.0 μm or 1000 nm, with even larger values up to 5 μm or more for optical energy in the waveguide having very long wavelengths in the infrared or even THz region of the spectrum. The material of the slot could be a vacuum containing a gaseous or plasma atomic species, or it could be a liquid or a solid. In the examples given the material was SiO₂ with an index of 1.444 at 1.55 μm wavelength. However, the index of the material need only be lower than the index of the surrounding layers of the waveguide immediately adjacent to the slot, and is certainly not limited to be 1.444 or below. Other desirable materials for the slot might be Si₃N₄ with an index that typically lies in the range of 1.8 to 2.2 depending on deposition conditions. Other materials could include crystalline or polycrystalline compounds, include those that might be epitaxially grown pseudomorphically on the silicon to form single-crystal waveguide structures.

The emitting or excited species in the slot regions of the waveguide could include materials with impurities. This could include rare-earth materials, including but not limited to impurities such as Er, Yb or Nd ions in amorphous, polycrystalline, or crystalline dielectric hosts. Other impurities as are often used to form materials that exhibit optical gain, and as are commonly found in a great variety of solid state lasers, could be used in the slot medium. These materials are not used in the present invention to provide optical gain, but instead are only required to provide spontaneous emission. Other examples would be species that are commonly used for lasers in liquids or other organic hosts such as dyes and other organic emitters. Additionally, materials used in the slot could be materials that are intrinsic optical emitters such as semiconductors with direct bandgaps, or semiconductors that will have acceptably high emission rates when placed in a slot waveguide configuration to enhance their emission. To function, such semiconductors should have an index of refraction that is lower than the adjacent waveguide layers in the slot waveguide geometry.

Finally, a highly efficient source of spontaneous emission into a waveguide will be a highly useful source for integration with other integrated components to form a subsystem for additional functionality. Such additional components to be integrated with this spontaneous emission source may include, but not be limited to, modulators, attenuators, filters, detectors, splitters, and couplers. Similarly, such efficient sources of spontaneous emission have many desirable attributes in addition to their efficiency, including their spectral characteristics that include broadband emission over a wide range of wavelengths. Emission bandwidths in excess of 50-100 nm are readily achieved, and with careful engineering of the emitting excited material in the slot even wider ranges can be achieved. This may include quantum dots with intentional dispersion in size, or the use of a variety of different impurities emitting at different wavelengths. Because the method of the present invention is not reliant on a resonator and resonant enhancement, it is inherently broadband in nature and can simultaneously provide enhancement to a broad range of wavelengths.

Due to the highly attractive features of the waveguide-coupled spontaneous emission source described by the present invention, it is also anticipated that it will enable important features in the systems to which it is applied. This may include highly energy or power efficient data communications systems providing connectivity between or on electronic integrated circuits, or other longer distance optical communications systems. It may also include applications where single excitations may produce single photons of light that will be produced in a guided mode with very high efficiency. It may also include sensor systems where the efficiency or spectral properties of the source realized by the present invention can bring advantage. It may also include signal processing systems where the efficiency or spectral properties of the source may bring advantage. It may also provide enabling features to energy conversion systems where, for example, incident light is converted into waveguide coupled light for subsequent conversion to useful energy by photovoltaic or thermal means.

We claim:

1. An optical device configured to serve as an optical source in an optical or optoelectronic system, said device comprising:
an optically emitting material producing spontaneous emission; and
an optical waveguide coupled to said optically emitting material;
wherein said spontaneous emission from said optically emitting material is emitted into at least one optical mode of said optical waveguide,
said optical device characterized in that:
said optical waveguide coupled to said optically emitting material does not provide optical gain;
the presence of said optical waveguide causes said spontaneous emission rate to be substantially more rapid than in the absence of said optical waveguide; and
said optical waveguide causes said more rapid spontaneous emission rate over a broad range of frequencies.

2. The device of claim 1, further characterized in that said optical waveguide does not comprise an optical resonator.

3. The device of claim 1, further characterized in that said optically emitting material and said waveguide are monolithically integrated on a single substrate.

4. The device of claim 1, further characterized in that the materials comprising the optically emitting material and the optical waveguide are formed by any combination of epitaxy, thin film deposition, and wafer bonding.

5. The device of claim 1, further characterized in that said optical or optoelectronic system is an optical communication system.

6. The device of claim 1, further characterized in that said optical or optoelectronic system is a system for converting optical energy into electrical energy

7. The device of claim 1, further characterized in that said optical or optoelectronic system is an optical sensor system.

8. The device of claim 1, further characterized in that said optical waveguide is a slot waveguide and said optically emitting material is contained within said slot.

9. The device of claim 1, further characterized in that said optical waveguide has a plurality of slots and said optically emitting material is contained within one or more of said plurality of slots.

10. The device of claim 1, further characterized in that more than 50% of said spontaneous emission is emitted into said optical waveguide.

11. The device of claim 1, further characterized in that more than 75% of said spontaneous emission is emitted into said optical waveguide.

12. The device of claim 1, further characterized in that more than 90% of said spontaneous emission is emitted into said optical waveguide.

13. The device of claim 1, further characterized in that said spontaneous emission rate is >2 times the rate that occurs in the absence of the waveguide.

14. The device of claim 1, further characterized in that said spontaneous emission rate is >5 times the rate that occurs in the absence of the waveguide.

15. The device of claim 1, further characterized in that said spontaneous emission rate is >10 times the rate that occurs in the absence of the waveguide.

16. The device of claim 1, further characterized in that said waveguide causes a substantial increase in the rate of the spontaneous emission compared to the case without a waveguide for emitters emitting over a frequency bandwidth of >1% of the emitting frequency.

17. The device of claim 1, further characterized in that said waveguide causes a substantial increase in the rate of the spontaneous emission compared to the case without a waveguide for emitters emitting over a frequency bandwidth of >2% of the emitting frequency.

18. The device of claim 1, further characterized in that said waveguide causes a substantial increase in the rate of the spontaneous emission compared to the case without a waveguide for emitters emitting over a frequency bandwidth of >5% of the emitting frequency.

19. The device of claim 1, further characterized in that said waveguide causes a substantial increase in the rate of the spontaneous emission compared to the case without a waveguide for emitters emitting over a frequency bandwidth of >10% of the emitting frequency.

20. The device of claim 1, further characterized in that said spontaneous emitting material is a dielectric containing a rare-earth ion.

21. The device of claim 1, further characterized in that said spontaneous emitting material is SiO₂ containing a rare-earth ion.

22. The device of claim 1, further characterized in that said spontaneous emitting material is silicon nitride containing a rare-earth ion.

23. The device of claim 1, further characterized in that said spontaneous emitting material is a dielectric comprising a mixture of silicon, oxygen, and nitrogen and containing a rare-earth ion.

24. The device of claim 1, further characterized in that said spontaneous emitting material is SiO₂ containing Er, Nd, or Yb.

25. The device of claim 1, further characterized in that said spontaneous emitting material is a semiconductor.

26. The device of claim 1, further characterized in that said spontaneous emitting material is a direct-bandgap semiconductor.

27. The device of claim 1, further characterized in that said spontaneous emitting material is excited by electrical current.

28. The device of claim 1, further characterized in that said spontaneous emitting material is excited by optical energy.

29. The device of claim 1, further characterized in that said spontaneous emitting material is a nonlinear material exhibiting parametric spontaneous emission.

30. The device of claim 8, further characterized in that said slot waveguide has high index layers comprised of a semiconductor.

31. The device of claim 30, further characterized in that said semiconductor is Si or Ge.

32. The device of claim 30, further characterized in that said semiconductor is a III-V semiconductor.

33. The device of claim 5, further characterized in that optoelectronic source has enhanced modulation bandwidth for use in said optical communications system.

34. The device in claim 6, further characterized in that optoelectronic system is a solar concentrator for photovoltaic energy generation.

35. The device of claim 1, further characterized in that said waveguide has a reflector on one end to direct spontaneous emission into a preferred direction.
